(19) United States
(12) Patent Application Publication
(10) Pub. No.: US 2008/0012467 A1
(43) Pub. Date: Jan. 17, 2008

(54) Method for Treating a Cathode Panel, Cold Cathode Field Emission Display Device, and Method for Producing the Same

(76) Inventor: Eisuke Negishi, Tokyo (JP)

Correspondence Address: RADER FISHMAN & GRAUER PLLC, LION BUILDING, 1233 20TH STREET N.W., SUITE 501, WASHINGTON, DC, 20036, US

(21) Appl. No.: 11/587,858

(22) PCT Filed: May 13, 2005
(86) PCT No.: PCT/JP05/09210

§ 371 Date: Feb. 12, 2007

(30) Foreign Application Priority Data
May 31, 2004 (JP) 2004-161153

(51) Int. Cl. H01J 1/62; F23Q 23/08; H01J 9/04

(52) U.S. Cl. 313/495; 445/24; 445/3

(57) ABSTRACT

A method for treating a cathode panel, which is used for obtaining a cathode panel free of an electron emitter area recognized as a luminescent spot when the cold cathode field emission display device collectively makes the darkest display. A method for treating a cathode panel (CP) having a plurality of electron emitter areas arrayed in a two-dimensional matrix form for use in producing a cold cathode field emission display device having a predetermined internal pressure P₀, wherein the method includes: (A) placing the cathode panel (CP) in a treatment chamber (100) having a predetermined internal pressure P₁ (where P₁>P₀, preferably P₁>>P₀); and then (B) applying an inspection voltage (V_{INS}) to each electron emitter area such that each electron emitter area emits electrons, causing discharge in an electron emitter area having an electron emission amount larger than that of another electron emitter area.

### TECHNICAL FIELD

The present invention relates to a method for treating a cathode panel constituting a cold cathode field emission display device, a method for producing a cold cathode field emission display device using the method for treating a cathode panel, and a cold cathode field emission display device obtained by the method for producing a cold cathode field emission display device.

### BACKGROUND ART

As image display devices which will possibly replace cathode-ray tubes (CRTs) currently widely spread, plane-type (flat panel type) display devices are vigorously studied. Examples of the plane-type display devices include a liquid crystal display (LCD), an electroluminescence display (ELD), and a plasma display (PDP). In addition, a cold cathode field emission display device in which a solid material can emit electrons into a vacuum without using thermal excitation, i.e., a so-called field emission display (FED) has been proposed, and has attracted attention since it advantageously achieves color display with high resolution and high luminance and causes low power consumption.

The cold cathode field emission display device (hereinafter, frequently referred to simply as “display device”) generally includes a cathode panel having electron emitter areas arrayed in a two-dimensional matrix form corresponding to respective subpixels, and an anode panel having a fluorescent region with which electrons emitted from the electron emitter areas collide and which is excited to emit light, wherein the cathode panel and the anode panel are disposed through a vacuum layer. In the cathode panel, the electron emitter areas arrayed in a two-dimensional matrix form, each of which constitutes one subpixel, generally have a plurality of cold cathode field emitter elements (hereinafter, frequently referred to simply as “field emitter element(s)”). Examples of field emitter elements include those of Spindt type, edge type, flat type, or plane type.

A diagrammatic fragmentary end view of a conventional display device using a Spindt-type field emitter element as an example is shown in FIG. 14, and a partial, diagrammatic perspective view of a cathode panel CP and an anode panel AP separated from each other is shown in FIG. 15. The Spindt-type field emitter element constituting the display device includes a cathode electrode 11 formed on a support 10, an insulating layer 12, a gate electrode 13 formed on the insulating layer 12, openings 14 (a first opening 14A formed in the gate electrode 13 and a second opening 14B formed in the insulating layer 12), and a conical electron emitter 15 formed on the cathode electrode 11 at the bottom of the second opening 14B. The cathode electrode 11 is in the form of a strip extending in a first direction (direction parallel to the plane of the paper of FIG. 14), and the gate electrode 13 is in the form of a strip extending in a second direction different from the first direction (direction perpendicular to the plane of the paper of FIG. 14). The overlap region where the strip-form cathode electrode 11 and the strip-form gate electrode 13 overlap corresponds to an electron emitter area EA.

On the other hand, the anode panel AP has a structure comprising a fluorescent region 22 (specifically, a fluorescent region 22R emitting red light, a fluorescent region 22G emitting green light, and a fluorescent region 22B emitting blue light) having a predetermined pattern formed on a substrate 20 wherein the fluorescent region 22 is covered with an anode electrode 24. Alight absorbing layer (black matrix) 23 comprised of a light absorbing material, such as carbon, is buried between the fluorescent regions 22 to prevent the occurrence of color turbidity in the display image, i.e., optical cross talk. In FIG. 14, reference numeral 21 designates a barrier, reference numeral 25 designates a spacer, and reference numeral 26 designates a spacer holder.

A voltage across the cathode electrode 11 and the gate electrode 13 is applied, and the resultant electric field causes the electron emitter 15 to emit electrons from its tip portion due to a quantum tunnel effect. The electrons are attracted by the anode electrode 24 in the anode panel AP, and collide with the fluorescent region 22 formed between the anode electrode 24 and the substrate 20, so that the fluorescent region 22 is excited to emit light, thus obtaining a desired image. The operation of the field emitter element is basically controlled by changing the voltage across the gate electrode 13 and the cathode electrode 11.

In the design of a display device, the selection of the target luminance and contrast for achieving the brightest display leads to a target luminance for achieving the darkest display. For obtaining an emission current with which the target luminance for achieving the darkest display is achieved, a voltage difference ΔV (=V_{G0}−V_{C0}) between a voltage V_{G0} applied to the gate electrode and a voltage V_{C0} applied to the cathode electrode is determined. This voltage difference ΔV (=V_{G0}−V_{C0}) is referred to as “cut-off voltage V_{CUT}”.

By the way, generally, it is difficult to produce uniform electron emitters 15, especially electron emitters having uniform tip portions. Dispersion in the electron emission properties of the electron emitters 15 results in dispersion in the states of electron emission of the electron emitter areas EA. A display device having a working voltage equal or close to the cut-off voltage V_{CUT} makes the darkest display. However, even in the display device having a voltage equal or close to the cut-off voltage V_{CUT}, when an electron emitter area emitting electrons is present, the display device collectively makes the darkest display, but the electron emitter area emitting electrons is disadvantageously recognized as a luminescent spot.

For preventing the luminance from lacking uniformity between the electron emitter areas EA, a technique of forming a resistance layer between the cathode electrode and the electron emitter is disclosed in, for example, U.S. Pat. Nos. 4,940,916 and 5,194,780.

The techniques disclosed in these U.S. patents effectively render the luminance uniform between the electron emitter areas EA when the emission current is large. However, the emission current is small at a voltage equal or close to the cut-off voltage V_{CUT}, and hence, even when the voltage difference ΔV (=V_{G0}−V_{C0}) is low, the electron emitter area emitting a great number of electrons is inevitably recognized as a luminescent spot.

Accordingly, an object of the present invention is to provide a method for treating a cathode panel, which is used for obtaining a cathode panel free of an electron emitter area recognized as a luminescent spot when the working voltage is equal or close to the cut-off voltage V_{CUT}, namely, the cold cathode field emission display device collectively makes the darkest display, a method for producing a cold cathode field emission display device using the method for treating a cathode panel, and a cold cathode field emission display device obtained by the method for producing a cold cathode field emission display device.

### DISCLOSURE OF THE INVENTION

A method for treating a cathode panel of the present invention for achieving the above object is a method for treating a cathode panel having a plurality of electron emitter areas arrayed in a two-dimensional matrix form for use in producing a cold cathode field emission display device having a predetermined internal pressure P₀, wherein the method is characterized by comprising:

(A) placing the cathode panel in a treatment chamber having a predetermined internal pressure P₁ (where P₁>P₀, preferably P₁>>P₀); and then

(B) applying an inspection voltage V_{INS} to each electron emitter area such that each electron emitter area emits electrons, causing discharge in an electron emitter area having an electron emission amount larger than that of another electron emitter area.

A method for producing a cold cathode field emission display device of the present invention for achieving the above object is characterized by comprising:

Forming a cathode panel by:
(A) placing a cathode panel having a plurality of electron emitter areas arrayed in a two-dimensional matrix form in a treatment chamber having a predetermined internal pressure P₁; and then
(B) applying an inspection voltage V_{INS} to each electron emitter area such that each electron emitter area emits electrons, causing discharge in an electron emitter area having an electron emission amount larger than that of another electron emitter area; and subsequently
(C) separating a portion of the electron emitter areas in which discharge was produced from a portion of the electron emitter areas in which no discharge was produced; and

joining the cathode panel formed with an anode panel, the anode panel including a fluorescent region and an anode electrode formed on a substrate,

wherein the cold cathode field emission display device produced has a predetermined internal pressure P₀ (where P₀<P₁, preferably P₀<<P₁).

A cold cathode field emission display device of the present invention for achieving the above object is characterized by comprising:

a cathode panel formed by:
(A) placing a cathode panel having a plurality of electron emitter areas arrayed in a two-dimensional matrix form in a treatment chamber having a predetermined internal pressure P₁; and then
(B) applying an inspection voltage V_{INS} to each electron emitter area such that each electron emitter area emits electrons, causing discharge in an electron emitter area having an electron emission amount larger than that of another electron emitter area; and

subsequently
(C) separating a portion of the electron emitter areas in which discharge was produced from a portion of the electron emitter areas in which no discharge was produced; and

an anode panel joined with the cathode panel formed at their edges, the anode panel including fluorescent region and an anode electrode formed on a substrate,

wherein the cold cathode field emission display device has a predetermined internal pressure P₀ (where P₀<P₁, preferably P₀<<P₁).

In the method for treating a cathode panel of the present invention, the cold cathode field emission display device of the present invention, or the method for producing a cold cathode field emission display device of the present invention (hereinafter, these are collectively referred to simply as “the present invention”),

a desired construction is such that

the treatment chamber has an inspection electrode, in the step (A), the cathode panel is placed in the treatment chamber having a predetermined internal pressure P₁ and having the inspection electrode so that the electron emitter areas face the inspection electrode, and,

in the step (B), the inspection voltage V_{INS} is applied to each electron emitter area in a state such that a positive voltage is applied to the inspection electrode such that each electron emitter area emits electrons toward the inspection electrode.

In the above construction, the cathode panel is placed in the treatment chamber having a predetermined internal pressure P₁ and having the inspection electrode so that the electron emitter areas face the inspection electrode. Specifically, there may be employed any of the following methods:

(1) a method in which the cathode panel is placed in the treatment chamber preliminarily having a predetermined internal pressure P₁ so that the electron emitter areas face the inspection electrode;

(2) a method in which the cathode panel is placed in the treatment chamber so that the electron emitter areas face the inspection electrode, and then the treatment chamber is evacuated so that the pressure in the chamber becomes a predetermined internal pressure P₁; and

(3) a method in which the cathode panel is placed in the treatment chamber and the treatment chamber is evacuated so that the pressure in the chamber becomes a predetermined internal pressure P₁, and then the cathode panel is arranged so that the electron emitter areas face the inspection electrode.

In the present invention, the pressure P₀ is generally on the order of 10⁻³ to 10⁻⁶ Pa. The pressure P₁ may be determined eventually by conducting, with respect to a number of cathode panels or various pressures P₁, a test in which an inspection voltage V_{INS} is applied to each electron emitter area such that each electron emitter area emits electrons, causing discharge in an electron emitter area having an electron emission amount larger than that of another electron emitter area, but, it is preferred that, for example, P₁≧10³P₀ is satisfied. Further, it is preferred that the P₁ value is 1 to 1×10² Pa. When the P₁ value is too high (that is, the degree of vacuum in the treatment chamber is low), discharge maybe caused also in an electron emitter area having a smaller electron emission amount. On the other hand, when the P₁ value is too low (that is, the treatment chamber is of high vacuum), no discharge may be caused in an electron emitter area having an electron emission amount larger than that of another electron emitter area.

In the present invention, the inspection voltage V_{INS} may be determined eventually by conducting, with respect to a number of cathode panels or various inspection voltages V_{INS}, a test in which an inspection voltage V_{INS} is applied to each electron emitter area such that each electron emitter area emits electrons, causing discharge in an electron emitter area having an electron emission amount larger than that of another electron emitter area, but, for example, in the above preferred embodiment of the present invention, it is preferred that, for example, V_{CUT}≦V_{INS}≦1.1V_{CUT}, where V_{CUT} is a cut-off voltage of the cold cathode field emission display device.

In the method for treating a cathode panel according to the above preferred embodiment of the present invention, it is preferred that a portion of the electron emitter areas in which discharge was produced is separated from a portion of the electron emitter areas in which no discharge was produced. In this mode of the method for treating a cathode panel of the present invention, the method for producing a cold cathode field emission display device of the present invention, or the cold cathode field emission display device of the present invention, a specific method for separating a portion of the electron emitter areas in which discharge was produced (hereinafter, frequently referred to as “discharge site”) from a portion of the electron emitter areas in which no discharge was produced (hereinafter, frequently referred to as “non-discharge site”) is such that a discharge site is specified using a microscope or an image inspection machine, or a discharge site is specified using a short-circuiting site inspection machine when short-circuiting occurs due to the discharge, and then the discharge site is separated from a non-discharge site.

As an example of the method for separating a discharge site from a non-discharge site, there can be mentioned a method in which the discharge site is removed using an external physical or chemical action, specifically, a method in which all or part of the discharge site is melt-cut and fused using laser or cut and removed in accordance with a lithography technique and an etching technique. Alternatively, the discharge site can be separated from the non-discharge site by, for example, in forming the second electrode (gate electrode) in the form of a strip extending parallel to the second direction, forming one or a plurality of groove portions (notch portions) extending parallel to the second direction in a portion or portions of the second electrode (gate electrode) in the overlap region where the first electrode (cathode electrode) and the second electrode (gate electrode) overlap, and melt-cutting, fusing, cutting, and removing a region of the discharge site positioned at the end of the groove portion. Further alternatively, the discharge site may be separated from the non-discharge site by scanning a laser beam, and, if desired, the discharge site may be erased. Examples of methods for inspecting a short-circuiting site include a method in which an electric resistance between the first electrode (cathode electrode) and the second electrode (gate electrode) or accidental heat generation is measured to inspect the occurrence of short-circuiting, a method in which a voltage across the first electrode (cathode electrode) and the second electrode (gate electrode) is applied and the resultant current is measured, and a method in which a current is allowed to flow the first electrode (cathode electrode) to the second electrode (gate electrode) to measure a voltage between the first electrode (cathode electrode) and the second electrode (gate electrode), and these tests can be performed in air (in a room or the like), but they may be performed in a vacuum. Alternatively, as described in the method for inspecting a cathode panel disclosed in Japanese Patent Application prior-to-examination Publication (kohyo) No. 2001-512239, a short-circuiting site may be detected using a magnetic head from a change in the magnetic flux induced by the current flowing the first electrode (cathode electrode) and the second electrode (gate electrode). The first electrode (cathode electrode) and the second electrode (gate electrode) are described later.

In the above preferred embodiment of the present invention, the inspection voltage V_{INS} may be constant, or the inspection voltage V_{INS} may be increased with time. In the latter, the increasing of the inspection voltage V_{INS} with time may be either linear or stepwise. Further, in the latter, the construction can be in which an emission current resulting from the electrons emitted from the electron emitter areas (e.g., an emission current flowing the inspection electrode) is measured and, when the emission current has reached a predetermined value, the increasing of the inspection voltage V_{INS} is stopped, but the construction is not limited to this. The predetermined value of the emission current may be determined eventually by conducting, with respect to a number of cathode panels, a test in which an inspection voltage V_{INS} is applied to each electron emitter area such that each electron emitter area emits electrons, causing discharge in an electron emitter area having an electron emission amount larger than that of another electron emitter area.

In the present invention, it is preferred that the inspection voltage V_{INS} is of a sinusoidal wave or a pulsed direct voltage, and, in the latter, it is preferred that the pulse occupation rate (duty factor) is 10 to 90% from the viewpoint of causing discharge in a short application time. The time during which the inspection voltage V_{INS} is applied (voltage application time) may be determined eventually by conducting, with respect to a number of cathode panels, a test in which an inspection voltage V_{INS} is applied to each electron emitter area such that each electron emitter area emits electrons, causing discharge in an electron emitter area having an electron emission amount larger than that of another electron emitter area. When the inspection voltage V_{INS} is of a sinusoidal wave, in the construction in which the inspection voltage V_{INS} is constant, the form of the sinusoidal wave is always constant. On the other hand, in the construction in which the inspection voltage V_{INS} is increased with time, the amplitude of the sinusoidal wave is increased with time. When the inspection voltage V_{INS} is of a pulsed direct voltage, in the construction in which the inspection voltage V_{INS} is constant, the value of the pulsed direct voltage is always constant. On the other hand, in the construction in which the inspection voltage V_{INS} is increased with time, the value of the pulsed direct voltage is increased with time.

When each electron emitter area is comprised of a cold cathode field emitter element,
V_{INS}=V_{G-INS}−V_{C-INS}
is satisfied where V_{C-INS} is a voltage applied to the cathode electrode and V_{G-INS} is a voltage applied to the gate electrode.

In the present invention, the positive voltage applied to the inspection electrode may be a voltage such that the inspection electrode attracts the electrons emitted from the electron emitter areas by an electric field resulting from applying the inspection voltage V_{INS} to each electron emitter area in the treatment of the cathode panel, thus surely preventing an undesired portion of the cathode panel from being charged due to the collision of electrons, for example, the positive voltage can be about 1 kV or less. When the voltage applied to the inspection electrode is too high, undesired discharge may be caused between the inspection electrode and the electron emitter areas.

The treatment chamber having an inspection electrode may include, for example:

a housing having an opening in the top;

an inspection stand, disposed in the housing, for holding a cathode panel;

a vacuum means for creating a vacuum in the housing;

an inspection voltage applying portion having a structure such that it is capable of being in contact with the end of each of the first electrode (cathode electrode) and the second electrode (gate electrode);

an inspection substrate, put on the top of the housing having an opening, having an inspection electrode; and

a voltage control means for applying a voltage to the inspection electrode, the first electrode (cathode electrode), and the second electrode (gate electrode).

In the above preferred embodiment of the present invention, with respect to each electron emitter area, there is no particular limitation, but it is preferred that each electron emitter area includes a first electrode extending in a first direction, a second electrode extending in a second direction different from the first direction, and one or a plurality of electron emitter elements formed in the overlap region between the first electrode and the second electrode.

Each electron emitter area includes one or a plurality of electron emitter elements, and each electron emitter element may include a cold cathode field emitter element (hereinafter, frequently referred to simply as “field emitter element”) which includes, for example:

(a) a cathode electrode formed on a support;

(b) an insulating layer covering the support and cathode electrode;

(c) a gate electrode formed on the insulating layer;

(d) a plurality of openings formed in portions of the gate electrode and portions of the insulating layer in the overlap region between the cathode electrode and the gate electrode; and

(e) an electron emitter exposed to the bottom of each opening,

wherein the cathode electrode corresponds to the first electrode and the gate electrode corresponds to the second electrode. The overlap region between the cathode electrode and the gate electrode corresponds to the electron emitter area.

In the present invention, discharge is produced in an electron emitter area having an electron emission amount larger than that of another electron emitter area, and, when the electron emitter area is comprised of the above-mentioned field emitter element, discharge in the electron emitter areas is specifically caused between the gate electrode and the electron emitter or between the gate electrode and the cathode electrode. When such discharge is produced, a damage of the gate electrode may cause short-circuiting between the gate electrode and the electron emitter or between the gate electrode and the cathode electrode.

The field emitter element is generally produced by the following method including:

(i) a step for forming a cathode electrode on a support;

(ii) a step for forming an insulating layer on the entire surface (on the support and cathode electrode);

(iii) a step for forming a gate electrode on the insulating layer;

(iv) a step for forming openings in the gate electrode and insulating layer in the overlap region between the cathode electrode and the gate electrode so that the cathode electrode is exposed to the bottom of each opening; and

(v) a step for forming an electron emitter on the cathode electrode at the bottom of the opening.

Alternatively, the field emitter element can be produced by the following method including:

(i) a step for forming a cathode electrode on a support;

(ii) a step for forming an electron emitter on the cathode electrode;

(iii) a step for forming an insulating layer on the entire surface (on the support and electron emitter, or on the support, cathode electrode, and electron emitter);

(iv) a step for forming a gate electrode on the insulating layer; and

(v) a step for forming openings in the gate electrode and insulating layer in the overlap region between the cathode electrode and the gate electrode so that the electron emitter is exposed to the bottom of each opening.

With respect to the type of the field emitter element, there is no particular limitation., and any of a Spindt-type field emitter element, an edge-type field emitter element, a plane-type field emitter element, a flat-type field emitter element, and a crown-type field emitter element may be used. It is preferred that each of the cathode electrode and the gate electrode has a strip form and the image from the cathode electrode and the image from the gate electrode cross at a right angle from the viewpoint of achieving the cold cathode field emission display device having a simplified structure.

The field emitter element may have a focusing electrode. Specifically, in the field emitter element, a focusing electrode may be formed on an interlayer dielectric layer which is further formed on the gate electrode and insulating layer, or a focusing electrode may be formed at the upper portion of the gate electrode. The focusing electrode is an electrode for focusing the track of electrons emitted from the openings toward the anode electrode to improve the luminance or to prevent optical cross talk between the adjacent pixels. In a so-called high voltage-type cold cathode field emission display device having a potential difference between the anode electrode and the cathode electrode on the order of several kV and having a relatively large distance between the anode electrode and the cathode electrode, the focusing electrode is especially effective. A relatively negative voltage is applied to the focusing electrode from a focusing electrode control circuit. The focusing electrode is not necessarily formed per field emitter element, and, for example, the focusing electrodes extend in a predetermined array direction of the field emitter elements to offer a focusing effect common to a plurality of field emitter elements.

Examples of materials constituting the cathode electrode, gate electrode, or focusing electrode include metals, such as aluminum (Al), tungsten (W), niobium (Nb), tantalum (Ta), molybdenum (Mo), chromium (Cr), copper (Cu), gold (Au), silver (Ag), titanium (Ti), nickel (Ni), cobalt (Co), zirconium (Zr)., iron (Fe), platinum (Pt), and zinc (Zn); alloys or compounds containing the above metal element (e.g., nitrides, such as TiN, and silicides, such as WSi₂, MoSi₂, TiSi₂, and TaSi₂); semiconductors, such as silicon (Si); carbon thin films of diamond or the like; and conductive metal oxides, such as ITO (indium-tin oxide), indium oxide, and zinc oxide. Examples of methods for forming the electrode include combinations of a deposition process, such as an electron beam deposition process or a hot filament deposition process, a sputtering process, a CVD process, or an ion plating process and an etching process; a screen printing process; a plating process (such as an electroplating process or an electroless plating process); a lift-off process; a laser ablation process; and a sol-gel process. The screen printing process or plating process enables direct formation of the electrode having, e.g., a strip form.

As a material constituting the insulating layer or interlayer dielectric layer, SiO₂ materials, such as SiO₂, BPSG (boro phospho silicated glass), PSG (phospho silicated glass), BSG (boro silicated glass) , AsSG (As silicated glass), PbSG (Pb silicated glass), SiON, SOG (spin on glass), low melting-point glass, and glass paste; SiN materials; and insulating resins, such as polyimide, can be used individually or in combination. In forming the insulating layer or interlayer dielectric layer, a known process, such as a CVD process, a coating process, a sputtering process, or a screen printing process, can be used.

A high-resistance film may be formed between the cathode electrode and the electron emitter. By virtue of the high-resistance film, the action of the field emitter element can be stabilized, and the electron emission properties can be uniform. Examples of materials constituting the high-resistance film include carbon materials, such as silicon carbide (SiC) and SiCN; SiN materials; semiconductor materials, such as amorphous silicon; and high melting-point metal oxides, such as ruthenium oxide (RuO₂), tantalum oxide, chromium oxide, and titanium oxide. Examples of methods for forming the high-resistance film include a sputtering process, a CVD process, and a screen printing process. The electric resistance per electron emitter may be generally 1×10to 1×10¹¹Ω, preferably several tens GΩ.

The plane form of the openings formed in the gate electrode or insulating layer (the form obtained by cutting the opening along a virtual plane parallel to the support surface) can be an arbitrary form, such as a circular form, an elliptical form, a rectangular form, a polygonal form, a rounded rectangular form, or a rounded polygonal form. The openings can be formed by, for example, isotropic etching or a combination of anisotropic etching and isotropic etching, and, depending on the method of forming the gate electrode, the openings can be formed directly in the gate electrode. The openings can also be formed in the insulating layer or interlayer dielectric layer by, for example, isotropic etching or a combination of anisotropic etching and isotropic etching.

Examples of supports constituting the cathode panel or substrates constituting the anode panel include a glass substrate, a glass substrate having an insulating film formed on its surface, a quartz substrate, a quartz substrate having an insulating film formed on its surface, and a semiconductor substrate having an insulating film formed on its surface, but, from the viewpoint of reducing the production cost, a glass substrate or a glass substrate having an insulating film formed on its surface is preferably used. Examples of glass substrates include high distortion-point glass, soda glass (Na₂O•CaO•SiO₂), borosilicate glass (Na₂O•B₂O₃•SiO₂) forsterite (2MgO•SiO₂), and lead glass (Na₂O•PbO•SiO₂).

In the cold cathode field emission display device, the anode electrode may be comprised of either a single anode electrode as a whole or a plurality of anode electrode units. In the latter, one anode electrode unit must be electrically connected to another anode electrode unit through a resistance film. Examples of materials constituting the resistance film include carbon materials, such as silicon carbide (SiC) and SiCN; SiN materials; high melting-point metal oxides, such as ruthenium oxide (RuO₂), tantalum oxide, chromium oxide, and titanium oxide; and semiconductor materials, such as amorphous silicon. The resistance film may have a sheet resistance of, for example, 1×10⁻¹ to 1×10¹⁰Ω/□, preferably 1×10³ to 1×10⁸Ω/□. The number (N) of the anode electrode units may be 2 or more. For example, when the total number of rows of the fluorescent regions arrayed in a straight line is n, N=n, or n=α·N (where a is an integer of 2 or more, preferably 10≦α≦100, further preferably 20≦α≦50). or N may be a value obtained by adding one to the number of spacers (mentioned below) disposed at predetermined intervals, a value equal to the number of pixels or subpixels, or a value obtained by dividing the number of pixels or subpixels by an integer. The sizes of the individual anode electrode units may be either the same irrespective of the positions of the anode electrode units or different depending on the positions of the anode electrode units.

When the cold cathode field emission display device makes color display, one row of the fluorescent regions arrayed in a straight line may be either comprised of a row occupied only by red light-emitting fluorescent regions, a row occupied only by green light-emitting fluorescent regions, or a row occupied only by blue light-emitting fluorescent regions or comprised of a row including red light-emitting fluorescent regions, green light-emitting fluorescent regions, and blue light-emitting fluorescent regions, which are successively arranged. The fluorescent region is defined as a fluorescent region producing one luminescent spot on the anode panel. One pixel is comprised of an assembly of one red light-emitting fluorescent region, one green light-emitting fluorescent region, and one blue light-emitting fluorescent region, and one subpixel is comprised of one fluorescent region (one red light-emitting fluorescent region, one green light-emitting fluorescent region, or one blue light-emitting fluorescent region). Further, the size corresponding to one subpixel in the anode electrode unit means a size of the anode electrode units surrounding one fluorescent region.

The anode electrode (including anode electrode units) may be formed using a conductor layer. Examples of methods for forming the conductor layer include various PVD processes, such as a deposition process, e.g., an electron beam deposition process or a hot filament deposition process, a sputtering process, an ion plating process, and a laser ablation process; various CVD processes; a screen printing process; a lift-off process; and a sol-gel process. Specifically, the anode electrode can be formed by forming a conductor layer comprised of a conductor and patterning the conductor layer in accordance with a lithography technique and an etching technique. Alternatively, the anode electrode can be obtained by forming a conductor layer through a mask or screen having a pattern of the anode electrode by a PVD process or a screen printing process. The resistance film can be formed by the similar method. Specifically, the resistance film can be obtained by forming a resistance film from a resistance material and patterning the resistance film in accordance with a lithography technique and an etching technique, or forming a resistance material film through a mask or screen having a pattern of the resistance film by a PVD process or a screen printing process. The average thickness of the anode electrode on the substrate (or at the upper portion of the substrate) (or the average thickness of the anode electrode on the top surface of a barrier which is formed as mentioned below) may be, for example, 3×10⁻⁸ m (30 nm) to 1.5×10⁻⁷ m (150 nm), preferably 5×10⁻⁸ m (50 nm) to 1×10⁻⁷ m (100 nm). The construction of the inspection electrode can be similar to that of, for example, the anode electrode.

The materials constituting the anode electrode may be appropriately selected according to the construction of the cold cathode field emission display device. Specifically, when the cold cathode field emission display device is of a transmissive type (in which the anode panel corresponds to the display side) and the anode electrode and the fluorescent region are stacked in this order on the substrate, not only the substrate but also the anode electrode must be transparent, and hence a transparent conductor, such as ITO (indium tin oxide), is used in the anode electrode. On the other hand, when the cold cathode field emission display device is of a reflective type (in which the cathode panel corresponds to the display side) or of a transmissive type wherein the fluorescent region and the anode electrode are stacked in this order on the substrate, examples of the materials constituting the anode electrode include metals, such as molybdenum (Mo) aluminum (Al), chromium (Cr), tungsten (W), niobium (Nb), tantalum (Ta), gold (Au), silver (Ag), titanium (Ti), cobalt (Co), zirconium (Zr), iron (Fe), platinum (Pt)., and zinc (Zn); alloys or compounds containing the above metal element (e.g., nitrides, such as TiN, and silicides, such as WSi₂, MoSi₂, TiSi₂, and TaSi₂); semiconductors, such as silicon (Si); carbon thin films of diamond or the like; and conductive metal oxides, such as ITO (indium-tin oxide), indium oxide, and zinc oxide. When a resistance film is formed, it is preferred that the anode electrode is comprised of a conductor which does not cause the resistance film to change in resistance, and, for example, when the resistance film is comprised of silicon carbide (SiC), it is preferred that the anode electrode is comprised of molybdenum (Mo).

Examples of arrangements of the anode electrode and the fluorescent region include (1) an arrangement in which the anode electrode is formed on the substrate and the fluorescent region is formed on the anode electrode, and (2) an arrangement in which the fluorescent region is formed on the substrate and the anode electrode is formed on the fluorescent region. In the arrangement (1), a so-called metal back film electrically connected to the anode electrode may be formed on the fluorescent region. In the arrangement (2), a metal back film may be formed on the anode electrode.

In the anode panel, there can be formed a plurality of barriers for preventing the electrons bouncing off the fluorescent regions or secondary electrons emitted from the fluorescent regions from entering other fluorescent regions to cause so-called optical cross talk (color turbidity).

Examples of plane forms of the barriers include a checkered form (form of parallel crosses), specifically, a form surrounding the four sides of the fluorescent region corresponding to one subpixel and having, for example, a plane form of substantially rectangular form (in a dotted pattern), and a strip form or striped form extending parallel to the opposite two sides of the substantially rectangular or striped fluorescent region. When the barriers are checkered, the form may either continuously surround the four sides of one fluorescent region or discontinuously surround the four sides of one fluorescent region. When the barriers are in a strip form or striped, the form may be either continuous or discontinuous. The barriers are formed and then, the barriers may be polished to planarize the top surfaces of the barriers.

Examples of methods for forming the barriers include a screen printing process, a dry film process, a photosensitive process, and a sandblasting forming process. The screen printing process is a method in which a barrier-forming material is put on a screen having openings formed in portions corresponding to the positions where barriers should be formed, and the material is allowed to pass through the openings of the screen using a squeegee to form a barrier-forming material layer on a substrate, followed by calcination of the barrier-forming material layer. The dry film process is a method in which a photosensitive film is laminated on a substrate, and portions of the photosensitive film where barriers will be formed are removed by exposure and development, and openings resulting from the removal of the film are plugged with a barrier-forming material, followed by calcination. The photosensitive film is burned and removed by calcination, and the barrier-forming material in the openings remains as barriers. The photosensitive process is a method in which a barrier-forming material layer having photosensitivity is formed on a substrate, and the barrier-forming material layer is patterned by exposure and development, followed by calcination. The sandblasting forming process is a method in which a barrier-forming material layer is formed on a substrate by, for example, screen printing or using a roll coater, a doctor blade, or a nozzle injection coater, and dried and then, portions of the barrier-forming material layer where barriers will be formed are covered with a mask layer, and then the exposed portions of the barrier-forming material layer are removed by a sandblasting method.

The fluorescent regions may be comprised of either fluorescent particles of single color or fluorescent particles of three primary colors. The array form of the fluorescent regions may be either dotted or striped. In the dotted or striped array form, gaps between the adjacent fluorescent regions may be plugged with a light absorbing layer (black matrix) for improving the contrast.

The fluorescent regions can be formed by a method in which, using a luminescent crystal particle composition prepared from luminescent crystal particles (e.g., fluorescent particles having a particle diameter of about 5 to 10 nm), for example, a photosensitive, red luminescent crystal particle composition (red fluorescent slurry) is applied to the entire surface, and exposed and developed to form a red light-emitting fluorescent region, and then a photosensitive, green luminescent crystal particle composition (green fluorescent slurry) is applied to the entire surface, and exposed and developed to form a green light-emitting fluorescent region, and further a photosensitive, blue luminescent crystal particle composition (blue fluorescent slurry) is applied to the entire surface, and exposed and developed to form a blue light-emitting fluorescent region. With respect to the average thickness of the fluorescent regions on the substrate, there is no particular limitation, but it is desired that the average thickness is 3 to 20 μm, preferably 5 to 10 μm.

The fluorescent material constituting the luminescent crystal particles can be appropriately selected from fluorescent materials conventionally known. In color display, preferred is a combination of fluorescent materials such that the materials have colors close to three primary colors having the color purity prescribed by NTSC wherein the three primary colors mixed have excellent white balance and the three primary colors individually have substantially the same and short afterglow time. Examples of fluorescent materials constituting the red light-emitting fluorescent region include (Y₂O₃:Eu), (Y₂O₂S:Eu), (Y₃Al₅O₁₂:Eu), (Y₂SiO₅:Eu), and (Zn₃(PO₄)₂:Mn}, and, of these, (Y₂O₃:Eu) or (Y₂O₂S:Eu) is preferably used. Examples of fluorescent materials constituting the green light-emitting fluorescent region include (ZnSiO₂:Mn), (Sr₄Si₃O₈Cl₄:Eu), (ZnS:Cu, Al), (ZnS:Cu, Au, Al), [(Zn, Cd)S:Cu, Al], (Y₃Al₅O₁₂:Tb), (Y₂SiOs:Tb), [Y₃(Al, Ga) O₁₂:Tb], (ZnBaO₄:Mn), (GbBO₃:Tb), (Sr₆SiO₃Cl₃:Eu), (BaMgAl₁₄O₂₃:Mn), (ScBO₃:Tb), (Zn₂SiO₄:Mn), (ZnO:Zn), (Gd₂O₂S:Tb), and (ZnGa₂O₄:Mn), and, of these, (ZnS:Cu, Al), (ZnS:Cu, Au, Al), [(Zn, Cd)S:Cu, Al], (Y₃Al₅O₁₂:Tb), [Y₃(Al, Ga)₅O₁₂:Tb], or (Y₂SiOs:Tb) is preferably used. Further, examples of fluorescent materials constituting the blue light-emitting fluorescent region include (Y₂SiOS:Ce), (CaWO₄:Pb), CaWO₄, YP_{0.85}V_{0.15}O₄, (BaMgAl₁₄O₂₃:Eu), (Sr₂P₂O₇:Eu), (Sr₂P₂O₇:Sn), (ZnS:Ag, Al), (ZnS:Ag), ZnMgO, and ZnGaO₄, and, of these, (ZnS:Ag) or (ZnS:Ag, Al) is preferably used.

It is preferred that a light absorbing layer for absorbing light from the fluorescent regions is formed between the barrier and the substrate from the viewpoint of improving the contrast of the display image. The light absorbing layer serves as a so-called black matrix. As a material constituting the light absorbing layer, a material capable of absorbing 99% or more of light from the fluorescent regions is preferably selected. Examples of such materials include carbon, metal thin films (e.g., chromium, nickel, aluminum, molybdenum, and alloys thereof), metal oxides (e.g., chromium oxide), metal nitrides (e.g., chromium nitride), heat-resistant organic resins, glass pastes, and glass pastes containing a black pigment or conductive particles of silver or the like, and specific examples include photosensitive polyimide resins, chromium oxide, and a chromium oxide/chromium stacked film. In the chromium oxide/chromium stacked film, the chromium film is in contact with the substrate. The light absorbing layer can be formed by a method appropriately selected depending on the material used, for example, a combination of a vacuum vapor deposition process or a sputtering process and an etching process, a combination of a vacuum vapor deposition process, a sputtering process, or a spin coating process and a lift-off process, a screen printing process, or a lithography technique.

In the cold cathode field emission display device, a space between the anode panel and the cathode panel is a vacuum (pressure P₀), and therefore a spacer must be placed between the anode panel and the cathode panel for preventing the cold cathode field emission display device from suffering a damage due to the atmospheric pressure. The spacer can be comprised of, for example, ceramic. Examples of ceramics constituting the spacer include mullite, alumina, barium titanate, lead titanate zirconate, zirconia, cordierite, barium borosilicate, iron silicate, glass ceramic materials, and the above materials containing titanium oxide, chromium oxide, iron oxide, vanadium oxide, or nickel oxide. In this case, the spacer can be produced by molding a so-called green sheet and calcining the sheet, and cutting the green sheet calcined article. On the surface of the spacer may be formed a conductor layer comprised of a metal or an alloy, a high-resistance layer, or a thin layer comprised of a material having a low coefficient of secondary electron emission. The spacer may be fixed by, for example, disposing it between a barrier and another barrier or disposing it between a spacer holder formed in the anode panel and another spacer holder.

Joining the cathode panel and the anode panel together at their edges may be conducted either using a bonding layer or using a frame comprised of an insulating rigid material, such as glass or ceramic, and a bonding layer in combination. When using a frame and a bonding layer in combination, the distance between the cathode panel and the anode panel can be long due to appropriate selection of the height of the frame, as compared to that obtained when using only a bonding layer. A material constituting the bonding layer is generally frit glass, but a so-called low melting-point metal material having a melting point of about 120 to 400° C. may be used. Examples of such low melting-point metal materials include In (indium; melting point: 157° C.); indium-gold low melting-point alloys; tin (Sn) high-temperature solder, such as Sn₈₀Ag₂₀ (melting point: 220 to 370° C.) and Sn₉₅Cu₅ (melting point: 227 to 370° C.) lead (Pb) high-temperature solder, such as Pb_{97.5}Ag_{2.5} (melting point: 304° C.), Pb_{94.5}Ag_{5.5} (melting point: 304 to 365° C.), and Pb_{97.5}Ag_{1.5}Sn_{1.0} (melting point: 309° C.); zinc (Zn) high-temperature solder, such as Zn₉₅Al₅ (melting point: 380° C.); tin-lead standard solder, such as Sn₅Pb₉₅ (melting point: 300 to 314° C.) and Sn₂Pb₉₈ (melting point: 316 to 322° C.); and brazing materials, such as Au₈₈Ga₁₂ (melting point: 381° C.) (where each subscript indicates atomic %).

The substrate, the support, and the frame, i.e., three members may be joined together either in a way such that the three members are joined together at the same time or in a way such that the substrate or support and the frame are first joined together on the first stage and then the remaining substrate or support and the frame are joined on the second stage. When joining the three members together at the same time or the joining on the second stage is conducted in a high-vacuum atmosphere, a space between the substrate, the support, the frame, and the bonding layer becomes a vacuum simultaneously with joining them. Alternatively, after joining the three members together, a space between the substrate, the support, the frame, and the bonding layer can be evacuated to create a vacuum. In evacuating the space after the joining, the pressure in the atmosphere for the joining may be either the atmospheric pressure or a reduced pressure, and gas constituting the atmosphere may be either air or inert gas including nitrogen gas or gas of element belonging to Group 0 of the Periodic Table (e.g., Ar gas).

In evacuating the space after the joining, the evacuation can be made through a chip tube preliminarily connected to the substrate and/or support. The chip tube is typically comprised of a glass tube, and is joined to the periphery of a through-hole formed in the substrate and/or support in an ineffective region (i.e., a region other than the effective region) using frit glass or the above-mentioned low melting-point metal material, and cut and sealed by heat-fusion after the space has reached a predetermined degree of vacuum. When the whole of the cold cathode field emission display device is heated and then cooled before cutting and sealing the chip tube, the space can release residual gas, so that the residual gas can be advantageously removed from the space by evacuation.

In the cold cathode field emission display device, a strong electric field resulting from the application of a voltage across the cathode electrode and the gate electrode is applied to the electron emitter, so that electrons are emitted from the electron emitter due to a quantum tunnel effect. The electrons are attracted by the anode panel due to the anode electrode in the anode panel, and collide with the fluorescent regions. The collision of the electrons with the fluorescent regions causes the fluorescent regions to emit light, which can be recognized as an image.

In the cold cathode field emission display device, the cathode electrode is connected to a cathode electrode control circuit, the gate electrode is connected to a gate electrode control circuit, and the anode electrode is connected to an anode electrode control circuit. These control circuits can be comprised of a known circuit. An output voltage VA of the anode electrode control circuit is generally constant, and can be, for example, 5 to 10 kV. It is desired that a V_{A}/d (unit: kV/mm) value is 0.5 to 20, preferably 1 to 10, further preferably 5 to 10 where d is a distance between the anode panel and the cathode panel (where 0.5 mm≦d≦10 mm).

In an actual operation of the cold cathode field emission display device, with respect to the voltage V_{C} applied to the cathode electrode and the voltage V_{G} applied to the gate electrode, when a voltage modulation mode is used as a gray level control mode, there can be employed the following systems:

(1) a system in which the voltage V_{C} applied to the cathode electrode is constant and the voltage V_{G} applied to the gate electrode is changed;

(2) a system in which the voltage V_{C} applied to the cathode electrode is changed and the voltage V_{G} applied to the gate electrode is constant; and

(3) a system in which the voltage V_{C} applied to the cathode electrode is changed and the voltage V_{G} applied to the gate electrode is changed.

In the present invention, a cathode panel is placed in a treatment chamber having a predetermined internal pressure P₁ (where P₁>P₀, preferably P₁>>P₀), and then an inspection voltage V_{INS} is applied to each electron emitter area, such that each electron emitter area emits electrons. The pressure P₁ (where P₁>P₀) in the treatment chamber makes a state such that discharge is likely to be caused in the electron emitter area. Therefore, for example, even when a voltage equal or close to the cut-off voltage V_{CUT} of the cold cathode field emission display device is applied to each electron emitter area as the inspection voltage V_{INS}, discharge is produced in an electron emitter area having an electron emission amount larger than that of another electron emitter area.

A portion of the electron emitter areas in which discharge was produced is separated from a portion of the electron emitter areas in which no discharge was produced. Therefore, there can be provided a cathode panel which is advantageous not only in that it is free of an electron emitter area recognized as a luminescent spot when the working voltage is equal or close to the cut-off voltage V_{CUT}, namely, the cold cathode field emission display device collectively makes the darkest display, but also in that it can make a uniform display image, and a cold cathode field emission display device having incorporated the cathode panel.

### BRIEF DESCRIPTION OF THE DRAWINGS

FIG. 1 is a diagrammatic fragmentary end view of a cold cathode field emission display device of the present invention using a Spindt-type cold cathode field emitter element.

FIGS. 2A and 2B are partial, diagrammatic perspective views of a cathode panel in the cold cathode field emission display device of the present invention.

FIG. 3 is a view diagrammatically showing the arrangement of the barrier, spacer, and fluorescent regions in the anode panel constituting the cold cathode field emission display device.

FIG. 4 is a view diagrammatically showing the arrangement of the barrier, spacer, and fluorescent regions in the anode panel constituting the cold cathode field emission display device.

FIG. 5 is a view diagrammatically showing the arrangement of the barrier, spacer, and fluorescent regions in the anode panel constituting the cold cathode field emission display device.

FIG. 6 is a view diagrammatically showing the arrangement of the barrier, spacer, and fluorescent regions in the anode panel constituting the cold cathode field emission display device.

FIG. 7 is a view diagrammatically showing the arrangement of the barrier, spacer, and fluorescent regions in the anode panel constituting the cold cathode field emission display device.

FIG. 8 is a view diagrammatically showing the arrangement of the barrier, spacer, and fluorescent regions in the anode panel constituting the cold cathode field emission display device.

FIG. 9 is a diagrammatic view showing a treatment chamber suitable for practicing the method for treating a cathode panel.

FIGS. 10A and 10B are diagrammatic fragmentary end views of a support and others for explaining the method for producing a Spindt-type cold cathode field emitter element.

FIGS. 11A and 11B are diagrammatic fragmentary end views, subsequent to FIG. 10B, of a support and others for explaining the method for producing a Spindt-type cold cathode field emitter element.

FIG. 12 is a diagrammatic view showing a modified example of the treatment chamber suitable for practicing the method for treating a cathode panel.

FIG. 13 is a diagrammatic fragmentary end view of a Spindt-type cold cathode field emitter element having a focusing electrode.

FIG. 14 is a diagrammatic fragmentary end view of a conventional cold cathode field emission display device using a Spindt-type cold cathode field emitter element.

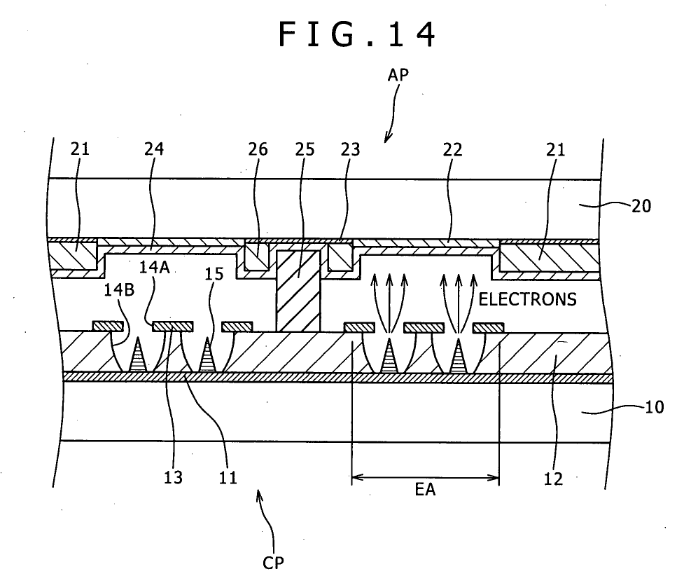

FIG. 15 is a partial, diagrammatic perspective view of a cathode panel in a conventional cold cathode field emission display device.

### BEST MODE FOR CARRYING OUT THE INVENTION

Hereinbelow, the present invention will be described with reference to the following Example and the accompanying drawings.

### EXAMPLE 1

Example 1 is directed to the method for treating a cathode panel of the present invention, a cold cathode field emission display device (hereinafter, referred to simply as “display device”), and a method for producing the same.

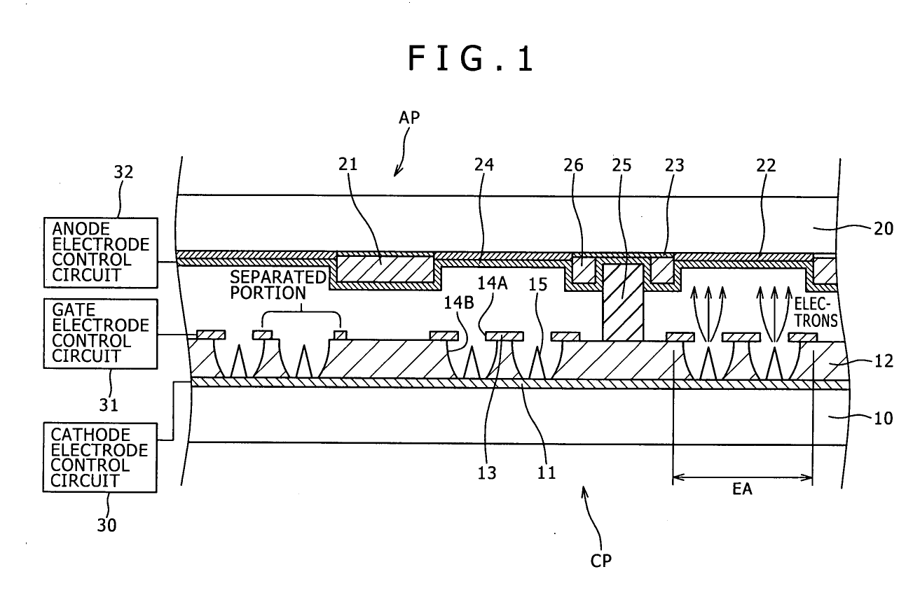

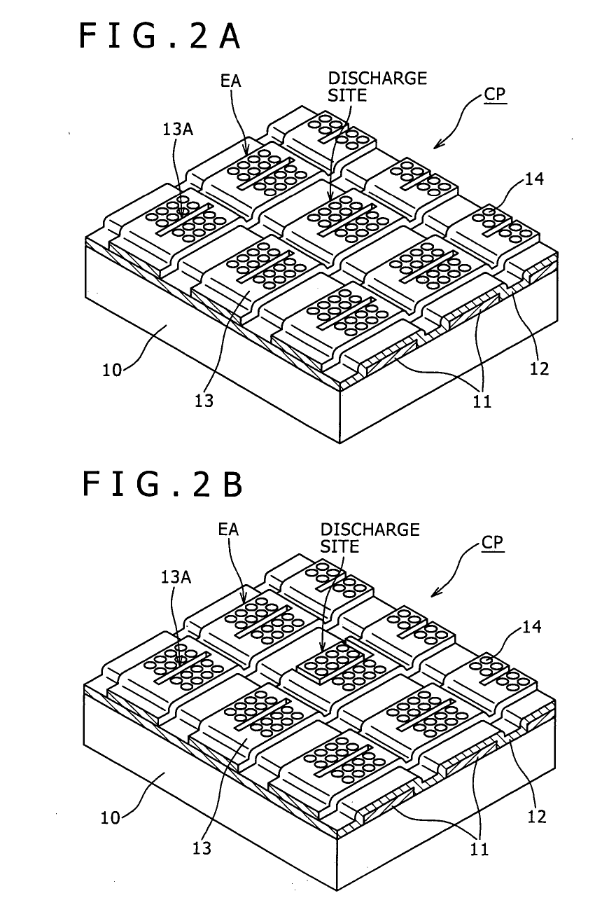

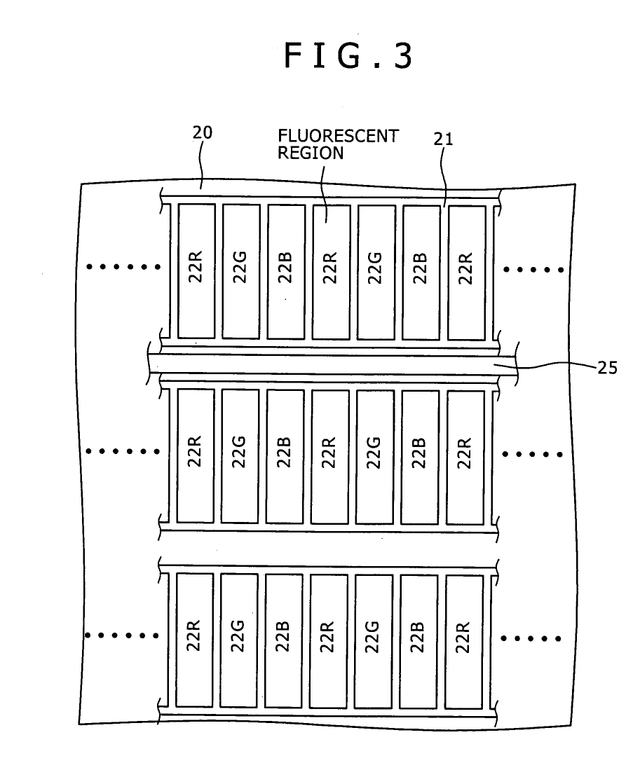

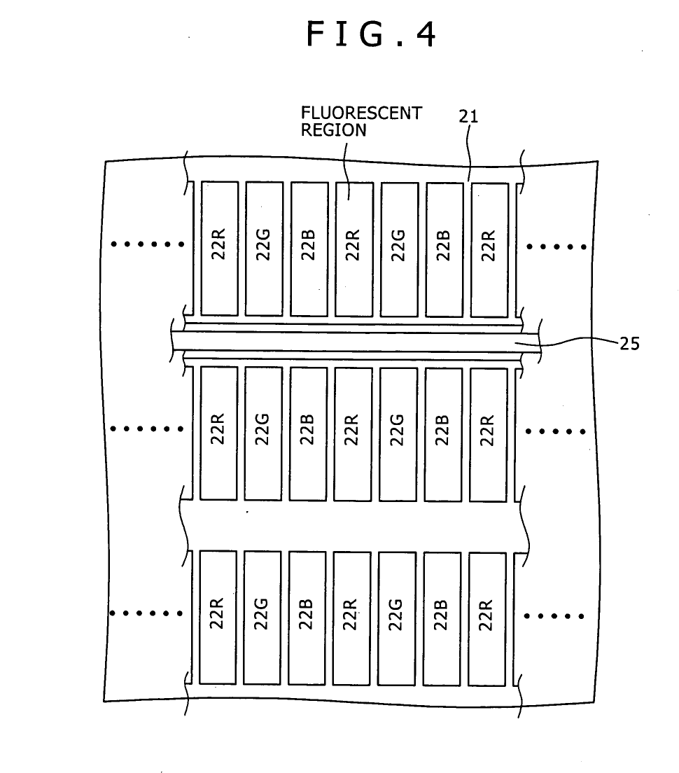

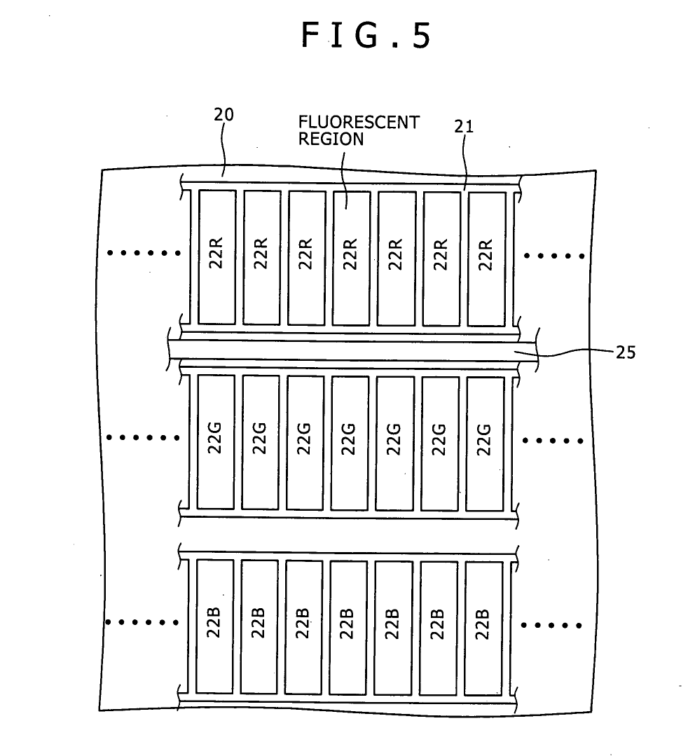

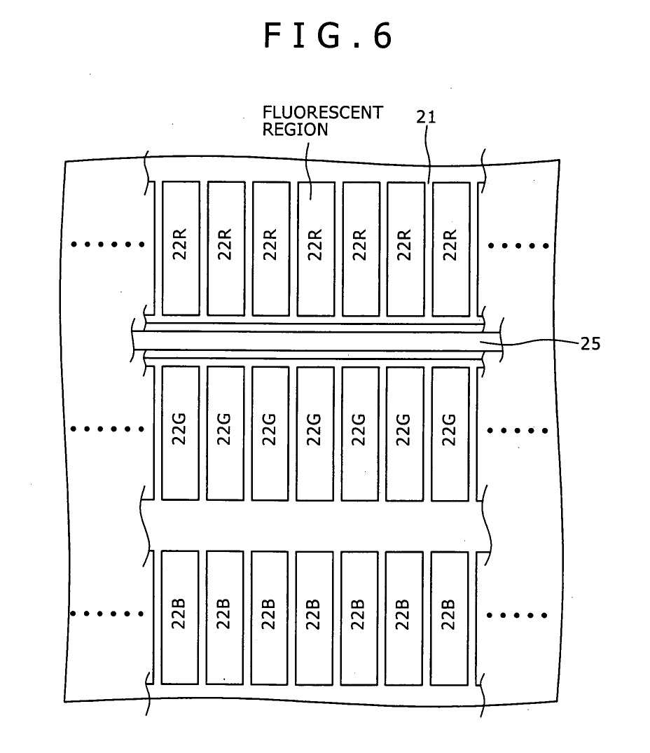

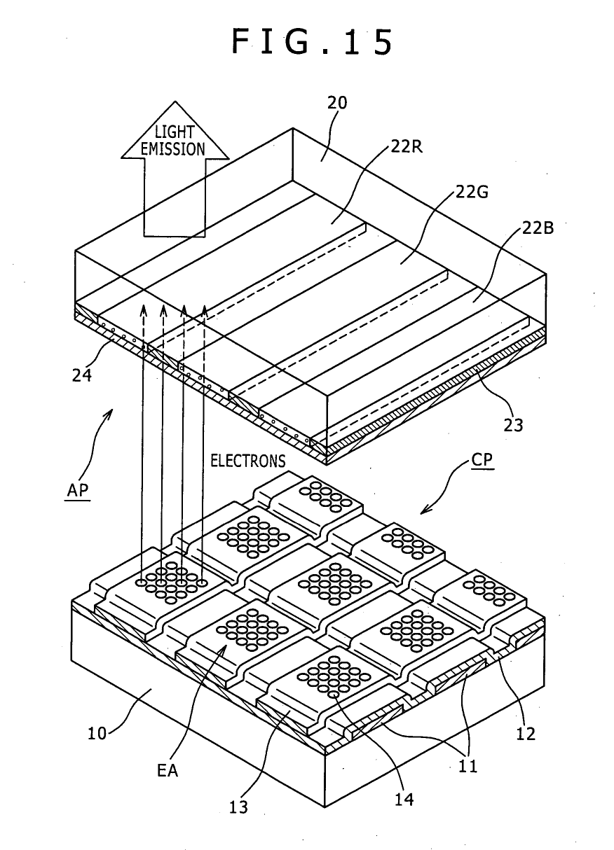

A diagrammatic fragmentary end view of the display device in Example 1 is shown in FIG. 1, and partial, diagrammatic perspective views of a cathode panel are shown in FIGS. 2A and 2B. Further, examples of arrangements of the fluorescent regions and others are shown in diagrammatic partial top views of FIGS. 3 to 8. The arrangement of the fluorescent regions and others in the anode panel AP shown in the diagrammatic fragmentary end view of FIG. 1 is shown in FIG. 4 or FIG. 6. In FIGS. 3 to 8, no anode electrode is shown. The diagrammatic perspective view of the anode panel AP in Example 1 is similar to that of the anode panel AP shown in FIG. 15.

The display device in Example 1 includes a cathode panel CP and an anode panel AP joined together at their edges, wherein a space between the cathode panel CP and the anode panel AP is a vacuum (pressure P₀). The cathode panel CP includes a support 10, and electron emitter areas EA arrayed in a two-dimensional matrix form on the support 10. On the other hand, the anode panel AP includes a substrate 20, a fluorescent region 22 (in color display, a red light-emitting fluorescent region 22R, a green light-emitting fluorescent region 22G, and a blue light-emitting fluorescent region 22B) formed on the substrate 20, and an anode electrode 24 covering the fluorescent region 22.

In Example 1, each electron emitter area EA includes a first electrode extending in a first direction (direction parallel to the plane of the paper of FIG. 1), a second electrode extending in a second direction different from the first direction (direction perpendicular to the plane of the paper of FIG. 1), and one or a plurality of electron emitter elements formed in the overlap region between the first electrode and the second electrode.

Each electron emitter element specifically includes a cold cathode field emitter element (hereinafter, referred to simply as “field emitter element”) which includes:

(a) a cathode electrode 11 formed on a support 10;

(b) an insulating layer 12 covering the support 10 and cathode electrode 11;

(c) a gate electrode 13 formed on the insulating layer 12;

(d) a plurality of openings 14 formed in portions of the gate electrode 13 and portions of the insulating layer 12 in the overlap region between the cathode electrode 11 and the gate electrode 13 (first openings 14A formed in the gate electrode 13 and second openings 14B formed in the insulating layer 12); and

(e) an electron emitter 15 exposed to the bottom of each opening 14,

wherein the cathode electrode 11 corresponds to the first electrode, the gate electrode 13 corresponds to the second electrode, and one electron emitter area EA corresponds to one subpixel.

The electron emitter 15 in Example 1 is comprised of a conical electron emitter. Specifically, the field emitter element in Example 1 is a Spindt-type field emitter element.

The cathode electrode 11 is in the form of a strip extending in a first direction (direction parallel to the plane of the paper of FIG. 1), and the gate electrode 13 is in the form of a strip extending in a second direction different from the first direction (direction perpendicular to the plane of the paper of FIG. 1) (see FIGS. 2A and 2B). The image from the cathode electrode 11 and the image from the gate electrode 13 cross at a right angle. That is, the first direction and the second direction cross at a right angle. The overlap region where the strip-form cathode electrode 11 and the strip-form gate electrode 13 overlap corresponds to the electron emitter area EA. One subpixel is comprised of the electron emitter area EA on the cathode panel side, and the fluorescent region 22 on the anode panel side facing the above electron emitter area EA. The pixels on the order of, e.g., several hundred thousand to several million are arrayed in the effective region.

The anode panel AP specifically includes the substrate 20, the fluorescent region 22 (the red light-emitting fluorescent region 22R, green light-emitting fluorescent region 22G, and blue light-emitting fluorescent region 22B) formed on the substrate 20 and between a barrier 21 and another barrier 21 formed on the substrate 20 and comprised of a number of fluorescent particles, and the anode electrode 24 formed on the fluorescent region 22. The anode electrode 24 is in the form of one thin sheet covering the effective region, and connected to an anode electrode control circuit 32. The anode electrode 24 is comprised of aluminum having a thickness of about 70 nm, and covers the barrier 21 and fluorescent region 22. A light absorbing layer (black matrix) 23 for preventing the occurrence of color turbidity in the display image, i.e., optical cross talk is formed between the fluorescent region 22 and the fluorescent region 22 and between the barrier 21 and the substrate 20.

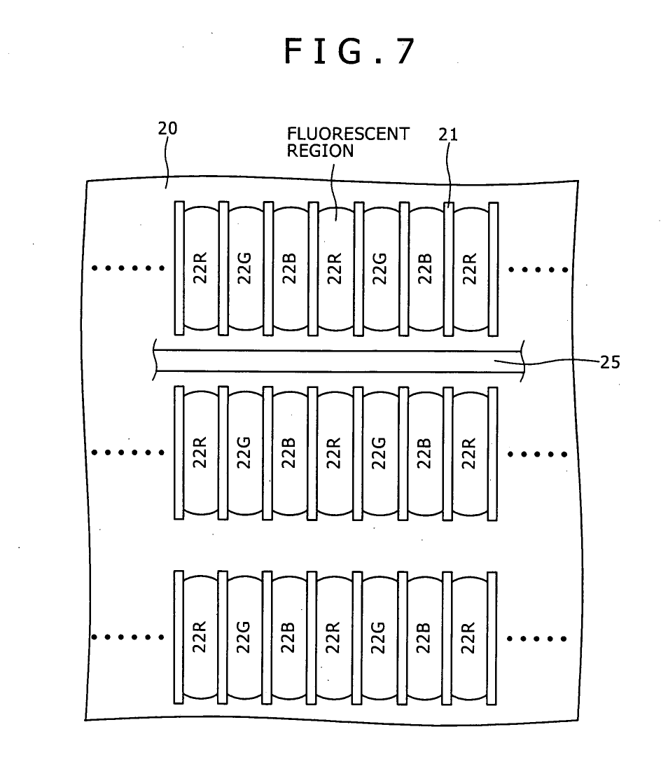

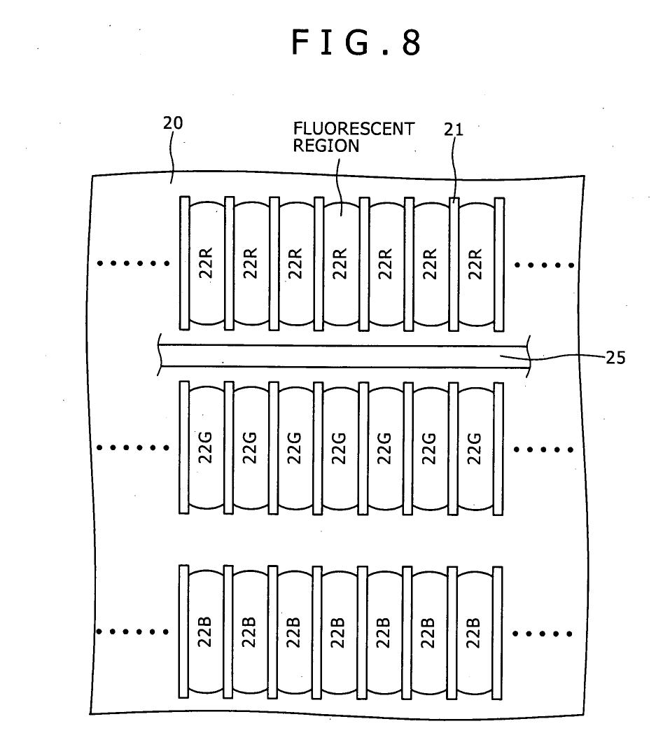

Examples of arrangements of the barrier 21, spacer 25, and fluorescent regions 22 are diagrammatically shown in FIGS. 3 to 8. Examples of plane forms of the barriers 21 include a checkered form (form of parallel crosses), specifically, a form surrounding the four sides of the fluorescent region 22 corresponding to one subpixel and having, for example, a plane form of substantially rectangular form (see FIGS. 3, 4, 5, and 6), and a strip form (striped form) extending parallel to the opposite two sides of the substantially rectangular (or strip-form) fluorescent region 22 (see FIGS. 7 and 8). In the fluorescent regions 22 shown in FIG. 7, the fluorescent regions 22R, 22G, 22B can be in the form of a strip extending in the vertical direction in FIG. 7. Part of the barrier 21 serves also as a spacer holder 26 for holding the spacer 25.

In the display device in Example 1, as shown in FIG. 1, the cathode electrode 11 is connected to a cathode electrode control circuit 30, the gate electrode 13 is connected to a gate electrode control circuit 31, and the anode electrode 24 is connected to an anode electrode control circuit 32. These control circuits can be comprised of a known circuit. An output voltage V_{A} of the anode electrode control circuit 32 is generally constant, and can be, for example, 5 to 10 kV. On the other hand, in an actual operation of the display device, with respect to the voltage V_{C} applied to the cathode electrode 11 and the voltage V_{G} applied to the gate electrode 13, there can be employed any one of the following systems:

(1) a system in which the voltage V_{C} applied to the cathode electrode 11 is constant and the voltage V_{G} applied to the gate electrode 13 is changed;

(2) a system in which the voltage V_{C} applied to the cathode electrode 11 is changed and the voltage V_{G} applied to the gate electrode 13 is constant; and

(3) a system in which the voltage V_{C} applied to the cathode electrode 11 is changed and the voltage V_{G} applied to the gate electrode 13 is changed.

A relatively negative voltage is applied to the cathode electrode 11 from the cathode electrode control circuit 30, a relatively positive voltage is applied to the gate electrode 13 from the gate electrode control circuit 31, and a positive voltage higher than that applied to the gate electrode 13 is applied to the anode electrode 24 from the anode electrode control circuit 32. In display made by the display device, for example, a scanning signal is input into the cathode electrode 11 from the cathode electrode control circuit 30, and a video signal is input into the gate electrode 13 from the gate electrode control circuit 31. A video signal may be input into the cathode electrode 11 from the cathode electrode control circuit 30, and a scanning signal may be input into the gate electrode 13 from the gate electrode control circuit 31. An electric field resulting from applying a voltage across the cathode electrode 11 and the gate electrode 13 causes the electron emitters 15 to emit electrons due to a quantum tunnel effect, and the electrons are attracted by the anode electrode 24 and pass through the anode electrode 24 and collide with the fluorescent regions 22, so that the fluorescent regions 22 are excited to emit light, thus obtaining a desired image. Accordingly, the operation of the display device is basically controlled by changing the voltage applied to the gate electrode 13 and the voltage applied to the electron emitters 15 through the cathode electrode 11.

The display device has a predetermined internal pressure P₀ (e.g., 1×10⁻⁴ Pa). The cut-off voltage V_{CUT} of the display device is 20 V.

The method for treating a cathode panel and the method for producing the display device in Example 1 are described below.

(Step-100)

A cathode panel CP having formed a number of electron emitter areas EA and field emitter elements is first prepared. A method for forming the field emitter element is described later.

(Step-110)

Then, the cathode panel CP is placed in a treatment chamber having a predetermined internal pressure P₁ (where P₁>P₀, specifically 1 Pa) and having an inspection electrode 131 so that the electron emitter areas EA face the inspection electrode 131.

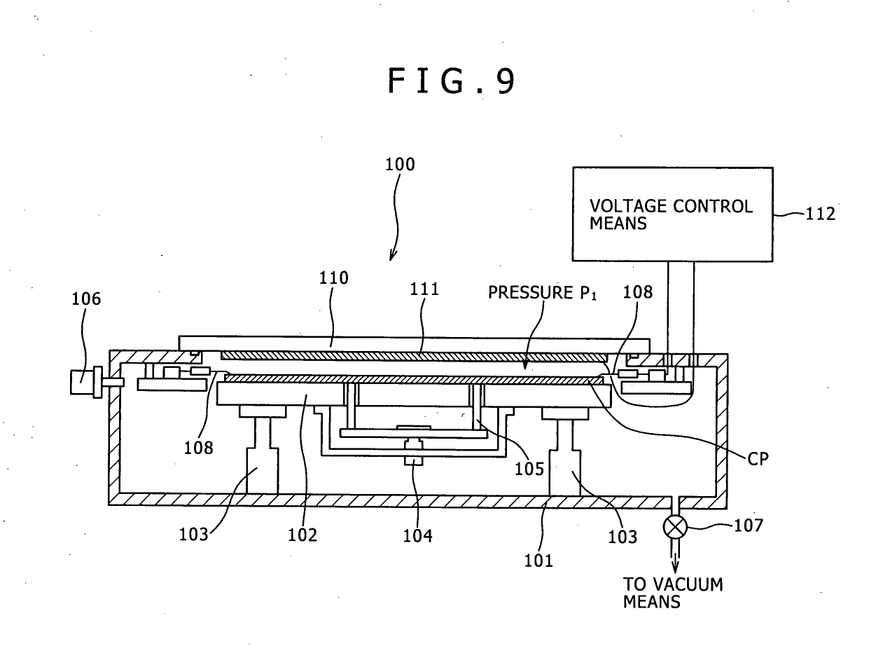

Specifically, a treatment chamber 100 shown in a diagrammatic view of FIG. 9 is used. When the cathode panel CP is not placed in a vacuum atmosphere, that is, a voltage across the cathode electrode 11 and the gate electrode 13 is applied in air, the dielectric strength between the cathode electrode 11 and the gate electrode 13 is too low to achieve the treatment.

The treatment chamber 100 includes:

a housing 101 having an opening in the top;

an inspection stand 102, disposed in the housing 101, for holding a cathode panel;

a vacuum means for creating a vacuum in the housing 101;

an inspection voltage applying portion 108 having a structure such that it is capable of being in contact with the end of each of the cathode electrode 11 and the gate electrode 13;

an inspection substrate 110, put on the top of the housing 101 having an opening, having an inspection electrode 131; and

a voltage control means 112 for applying a voltage to the inspection electrode 131, the cathode electrode 11, and the gate electrode 13.

Specifically, the treatment chamber 100 includes the housing 101 having an opening in the top. The inspection stand 102 is disposed in the housing 101 made of aluminum or stainless steel, and an inspection stand elevating cylinder 103 is provided under the inspection stand 102. The inspection stand elevating cylinder 103 is put on a not shown moving pedestal and movable together with the inspection stand 102 in the vertical direction in FIG. 9. A pin elevating cylinder 104 is further provided under the inspection stand 102, and the pin elevating cylinder 104 works to allow a pin 105 to move up and down in a through-hole in the inspection stand 102. The housing 101 is connected through a valve 107 to a vacuum means (not shown) comprised of a turbine molecular pump and a dry pump or the like, which can create a vacuum atmosphere in the housing 101. Further, in the housing 101 is disposed the inspection voltage applying portion 108 having a structure such that it is capable of being in contact with the end of each of the cathode electrode 11 and the gate electrode 13.

When short-circuiting is caused in the all cathode electrodes 11 at their ends, there is required only one inspection voltage applying portion 108 having a structure such that it is capable of being in contact with the end of the cathode electrode 11. When short-circuiting is caused in the all gate electrodes 13 at their ends, there is required only one inspection voltage applying portion 108 having a structure such that it is capable of being in contact with the end of the gate electrode 13. On the other hand, when the all cathode electrodes 11 are divided into P blocks and short-circuiting is caused in the cathode electrodes 11 in each block at their ends, the number of the required inspection voltage applying portions 108 having a structure such that they are capable of being in contact with the ends of the cathode electrodes 11 is P. When the all gate electrodes 13 are divided into Q blocks and short-circuiting is caused in the gate electrodes 13 in each block at their ends, the number of the required inspection voltage applying portions 108 having a structure such that they are capable of being in contact with the ends of the gate electrodes 13 is Q. By separating the end of the cathode electrode 11 where short-circuiting is caused from the cathode electrode 11 and separating the end of the gate electrode 13 where short-circuiting is caused from the gate electrode 13 prior to the assembly of the display device, a voltage can be independently applied to each of the cathode electrode 11 and the gate electrode 13 in an actual operation of the display device.

The inspection substrate 110 having the inspection electrode 131 comprised of an aluminum layer is put on the top of the housing 101 having an opening. The voltage control means 112 is connected to the inspection voltage applying portion 108 and the inspection electrode 131.

In the treatment of the cathode panel CP, the cathode panel CP is placed on the pin 105 which has been elevated, and the pin elevating cylinder 104 is operated to permit the pin 105 to go down, thus putting the cathode panel CP on the inspection stand 102. Then, the cathode panel CP put on the inspection stand 102 is placed in the housing 101 through a door (not shown) formed in the housing 101, and then a vacuum atmosphere (e.g., P₁=about 1 Pa) is created in the housing 101 by the vacuum means. The pressure in the housing 101 can be measured by means of a pressure gauge 106, such as a Pirani gauge or an ion gauge.

After the atmosphere in the housing 101 has reached a desired pressure (e.g., P₁=1 Pa), the inspection stand elevating cylinder 103 is operated to permit the inspection stand 102 to go up, thus placing the cathode panel CP so that the electron emitter areas EA in the cathode panel CP face the inspection electrode 131. A distance between the cathode panel CP and the inspection substrate 110 is, for example, 5 mm. In addition, the inspection voltage applying portion 108 is brought into contact with the end of each of the cathode electrode 11 and the gate electrode 13.

(Step-120)

Then, an inspection voltage V_{INS} of 20 V is applied to the all cathode electrodes 11 and all gate electrodes 13 from the voltage control means 112 through the inspection voltage applying portion 108. Further, for example, 0.8 kV is applied to the inspection electrode 131 from the voltage control means 112.

In Example 1, the inspection voltage V_{INS} is constant. That is, the pulsed direct voltage is always constant. Specifically, the inspection voltage V_{INS} is a pulsed direct voltage (=20 V) at 60 Hz, the pulse occupation rate (duty factor) is 50%, and the voltage application time (T) is one minute.

In this way, applying the inspection voltage V_{INS} across the cathode electrode 11 and the gate electrode 13 causes the all electron emitter areas EA to emit electrons toward the inspection electrode 131. Specifically, an electric field resulting from the application of the inspection voltage V_{INS} across the cathode electrode 11 and the gate electrode 13 causes the electron emitter 15 to emit electrons from its tip portion due to a quantum tunnel effect. The electrons are attracted by the inspection electrode 131 in the inspection substrate 110. Accordingly, an undesired portion of the cathode panel CP can be surely prevented from being charged due to the collision of electrons.

The above procedure causes discharge in an electron emitter area having an electron emission amount larger than that of another electron emitter area. The portion of the electron emitter areas EA in which discharge is produced is indicated by “discharge site” in FIGS. 2A and 2B. The discharge in the electron emitter areas EA at the discharge site is caused between the gate electrode 13 and the electron emitter 15 or between the gate electrode 13 and the cathode electrode 11. between the gate electrode 13 and the electron emitter 15 or between the gate electrode 13 and the cathode electrode 11 due to a damage of the gate electrode 13.

After completion of the treatment of the cathode panel CP, the atmosphere in the housing 101 is allowed to be under the atmospheric pressure, and the inspection stand elevating cylinder 103 is operated to permit the inspection stand 102 to go down, thus removing the inspection stand 102 holding the cathode panel CP from the housing 101.

(Step-130)

Then, a discharge site is detected in an atmospheric atmosphere. Specifically, the method disclosed in Japanese Patent Application prior-to-examination Publication (kohyo) No. 2001-512239, a method using an image inspection machine, or a wiring short-circuit test for measuring an electric resistance of the electron emitter or accidental heat generation to inspect the occurrence of short-circuiting may be employed. Then, the detected portion of the discharge site in the gate electrode 13 is separated from the other portion of the gate electrode 13. Specifically, the portion of the gate electrode is melt-cut using laser. In Example 1, in forming the gate electrode 13, one groove portion (notch portion) 13A extending parallel to the second direction is formed in a portion of the gate electrode 13 in the overlap region (see FIG. 2A). The region of the gate electrode 13 positioned at the end of the groove portion 13A is cut using a laser cutting machine as diagrammatically shown in FIG. 2B, thus separating the detected portion of the discharge site in the gate electrode 13 from the other portion of the gate electrode. In FIG. 1, the detected portion of the discharge site in the gate electrode 13 separated from the other portion of the gate electrode is indicated by “separated portion”.

(Step-140)

On the other hand, the anode panel AP having formed the fluorescent region 22, anode electrode 24, and others is prepared. Then, a display device is assembled. Specifically, for example, the spacer 25 is fitted to the spacer holder 26 formed in the effective region of the anode panel AP, and the anode panel AP and the cathode panel CP are arranged so that the fluorescent region 22 faces the electron emitter areas EA, and the anode panel AP and the cathode panel CP (specifically, the substrate 20 and the support 10) are joined together at their edges through a frame (not shown) formed from ceramic or glass. In joining them together, frit glass is applied to a joint portion of the frame and the anode panel AP and a joint portion of the frame and the cathode panel CP, and the anode panel AP, the cathode panel CP, and the frame are joined together and subjected to preliminary calcination to dry the frit glass, followed by main calcination at about 450° C. for 10 to 30 minutes. Then, a space between the anode panel AP, the cathode panel CP, the frame, and the frit glass (not shown) is evacuated through a through-hole (not shown) and a chip tube (not shown), and the chip tube is cut and sealed by heat-melting at a time when the pressure P₀ in the space has reached about 10⁻⁴ Pa. Thus, a vacuum can be created in the space between the anode panel AP, the cathode panel CP, and the frame. Alternatively, for example, the frame, the anode panel AP, and the cathode panel CP may be joined together in a high-vacuum atmosphere. Further alternatively, depending on the structure of the display device, the anode panel AP and the cathode panel CP may be joined together only with a bonding layer without a frame. Subsequently, connection to a required external circuit through a wiring is made, thus completing the display device.

In the thus obtained display device, an electron emitter area recognized as a luminescent spot is not present when the working voltage is equal or close to the cut-off voltage V_{CUT}, namely, the cold cathode field emission display device collectively makes the darkest display, making it possible to obtain an excellent uniform image.

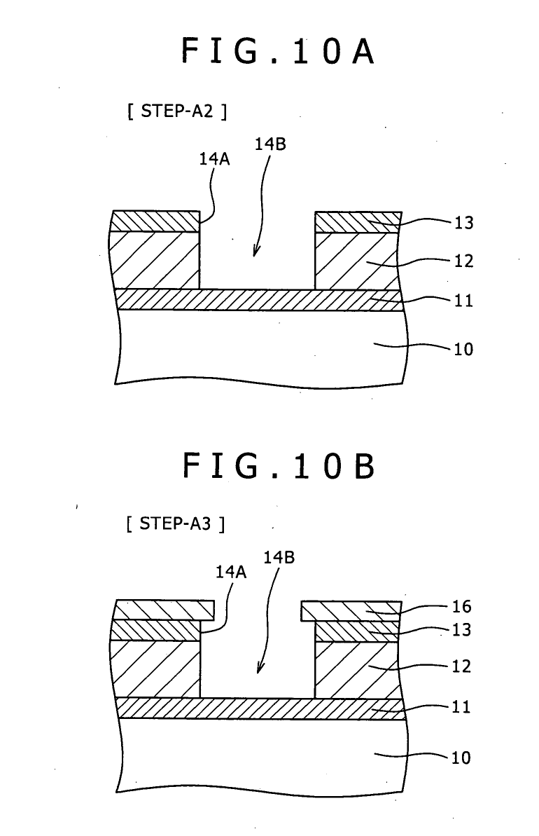

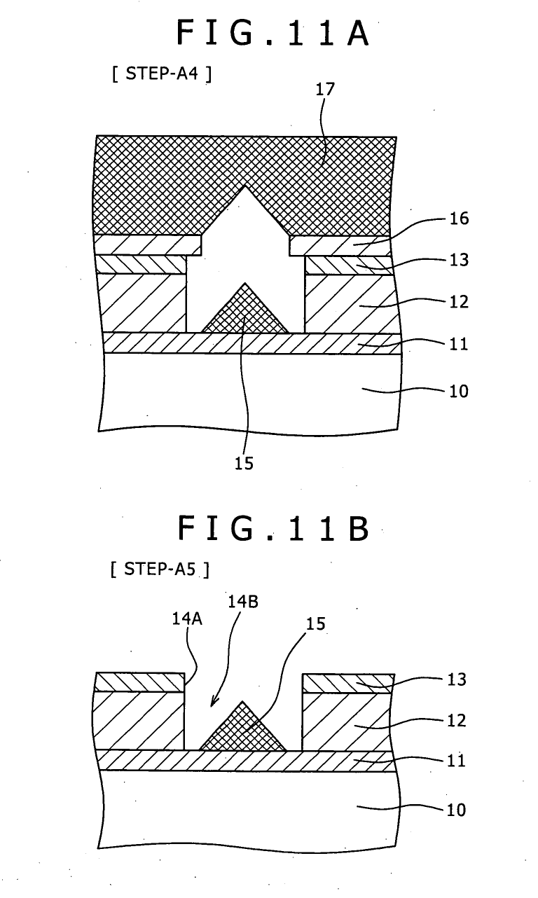

Hereinbelow, the method for producing a Spindt-type field emitter element will be described with reference to the diagrammatic fragmentary end views of the support 10 and others constituting the cathode panel of FIGS. 10A and 10B and FIGS. 11A and 11B.

The Spindt-type field emitter element can be basically obtained by a method in which the conical electron emitter 15 is formed from a metal material by vertical deposition. Specifically, evaporated particles enters in the vertical direction the first opening 14A formed in the gate electrode 13, and the amount of the evaporated particles which arrive at the bottom of the second opening 14B is gradually reduced utilizing a shielding effect of the overhung deposited material formed near the opening end of the first opening 14A, thus achieving self-alignment formation of the electron emitter 15 comprised of a conical deposited material. Here, a method in which a release layer 16 is preliminarily formed on the gate electrode 13 and insulating layer 12 to facilitate removal of the unnecessary overhung deposited material is described. In each of the drawings for explaining the method for producing a field emitter element, only one electron emitter is shown.

(Step-A0)

A conductor layer for cathode electrode comprised of, e.g., polysilicon is first formed on a support 10 comprised of, e.g., a glass substrate by a plasma CVD process, and then the conductor layer for cathode electrode is patterned in accordance with a lithography technique and a dry etching technique to form a strip-form cathode electrode 11. Then, an insulating layer 12 comprised of SiO₂ is formed on the entire surface by a CVD process.

(Step-A1)

Next, a conductor layer for gate electrode (e.g., Al layer) is formed on the insulating layer 12 by a sputtering process, and then the conductor layer for gate electrode is patterned in accordance with a lithography technique and a dry etching technique to obtain a strip-form gate electrode 13. In forming the gate electrode 13, one groove portion (notch portion) 13A (not shown in FIGS. 10A and 10B and FIGS. 11A and 11B) extending parallel to the second direction is also formed in a portion of the gate electrode 13 in the overlap region. The strip-form cathode electrode 11 extends in the horizontal direction in the drawings, and the strip-form gate electrode 13 extends in the direction perpendicular to the plane of the paper of the drawings.

The gate electrode 13 may be formed by, if necessary, a combination of a known thin film formation process, such as a PVD process, e.g., a vacuum vapor deposition process, a CVD process, a plating process, e.g., an electroplating process or an electroless plating process, a screen printing process, a laser ablation process, a sol-gel process, or a lift-off process and an etching technique. The screen printing process or plating process can directly form, for example, a strip-form gate electrode.

(Step-A2)

Then, a resist layer is formed again, and a first opening 14A is formed in the gate electrode 13 by etching, and further a second opening 14B is formed in the insulating layer so that the cathode electrode 11 is exposed to the bottom of the second opening 14B, and then the resist layer is removed, thus obtaining a structure shown in FIG. 10A.

(Step-A3)

Next, nickel (Ni) is deposited on the insulating layer 12 including the gate electrode 13 by oblique incident vacuum deposition while rotating the support 10 to form a release layer 16 (see FIG. 10B). In this instance, selection of a satisfactorily large incident angle (e.g., an incident angle of 65 to 85°) of the evaporated particles to the normal of the support 10 enables formation of the release layer 16 on the gate electrode 13 and insulating layer 12 with almost no nickel deposited on the bottom of the second opening 14B. The release layer 16 protrudes from the opening end of the first opening 14A like eaves, so that the diameter of the first opening 14A is substantially reduced.

(Step-A4)

Next, a conductor, e.g., molybdenum (Mo) is vertical-deposited on the entire surface (incident angle: 3 to 10°). In this instance, as shown in FIG. 11A, as a conductor layer 17 having an overhung form grows on the release layer 16, the substantial diameter of the first opening 14A is gradually reduced and hence, gradually only the evaporated particles which pass through a portion near the center of the first opening 14A are deposited on the bottom of the second opening 14B, so that a conical deposited material is formed on the bottom of the second opening 14B and the conical deposited material constitutes an electron emitter 15.

(Step-A5)

Subsequently, as shown in FIG. 11B, the release layer 16 is peeled off the surface of the gate electrode 13 and insulating layer 12 by a lift-off process to selectively remove the conductor layer 17 above the gate electrode 13 and insulating layer 12. Then, the sidewall of the second opening 14B formed in the insulating layer 12 is preferably etched by isotropic etching from the viewpoint of exposing the opening end of the gate electrode 13. The isotropic etching can be performed by either dry etching using radicals as main etching species, e.g., chemical dry etching, or wet etching using an etching solution. As the etching solution, for example, a 1:100 (volume ratio) mixture of a 49% aqueous solution of hydrofluoric acid and pure water can be used. Thus, a cathode panel having formed a plurality of Spindt-type field emitter elements can be obtained.

Hereinabove, the present invention is described with reference to the preferred Example, but the present invention is not limited to the Example. The construction and structure of the cathode panel, anode panel, cold cathode field emission display device, and cold cathode field emitter element described in the Example are merely examples and can be appropriately changed, and the methods for producing the anode panel, cathode panel, cold cathode field emission display device, or cold cathode field emitter element are also merely examples and can be appropriately changed. Further, various materials used in the production of the anode panel or cathode panel are also merely examples and can be appropriately changed. With respect to the display device, color display is generally described as an example, but monochromatic display can be made.

In the Example, the inspection voltage V_{INS} is constant, but the inspection voltage V_{INS} can be increased with time, and, in this case, the increasing of the inspection voltage V_{INS} with time may be either linear or stepwise. A construction maybe used such that an emission current flowing the inspection electrode 131 and resulting from the electrons emitted from the electron emitter areas is measured by means of an ammeter (not shown) disposed between the inspection electrode 131 and the voltage control means 112 and, when the emission current has reached a predetermined value, the increasing of the inspection voltage V_{INS} is stopped.

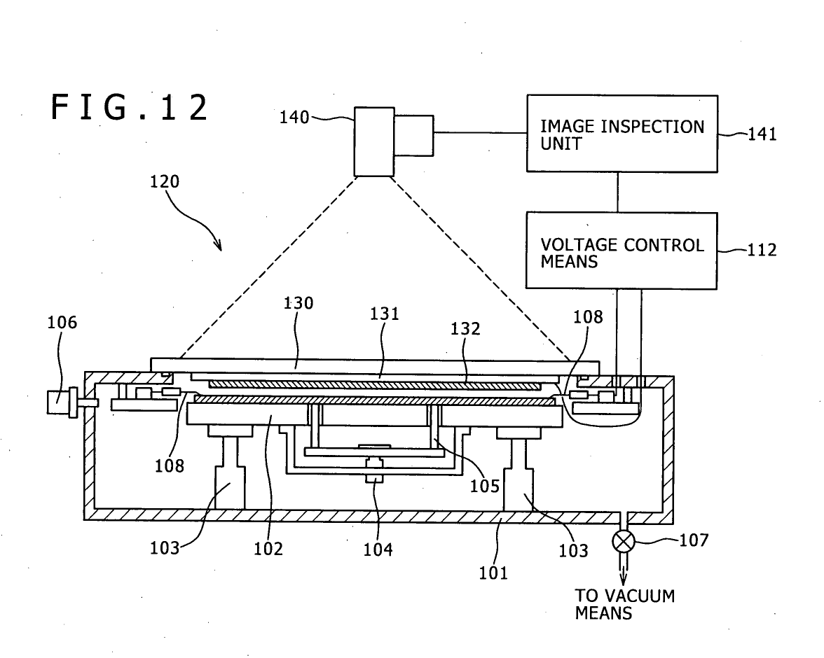

In the present invention, as a method for detecting the discharge site, an image display test which actually permits the cathode panel to emit electrons can be employed. A diagrammatic view of a treatment chamber 120 suitable for practicing the method for treating a cathode panel based on the image display test is shown in FIG. 12. In the treatment chamber 120, an inspection substrate 130 having an inspection electrode 131 and a fluorescent region 132 is put on the top of a housing 101 having an opening. An image receiver 140 having a CCD is provided above the inspection substrate 130. The image receiver 140 is connected to an image inspection unit 141. The construction and structure of the treatment chamber 120 and others may be the same as the construction and structure of the treatment chamber 100, and detailed descriptions of them are omitted.

In a step similar to the (Step-120) in Example 1, an inspection voltage V_{INS} of 20 V is applied to the all cathode electrodes 11 and all gate electrodes 13 from a voltage control means 112 through an inspection voltage applying portion 108, and further, for example, 0.8 kV is applied to the inspection electrode 131 from the voltage control means 112. Thus, electrons are emitted from the electron emitter areas EA, and attracted by the inspection electrode 131 provided on the inspection substrate 130 and collide with the fluorescent region 132, so that the fluorescent region 132 facing the electron emitter area having an electron emission amount larger than that of another electron emitter area is excited to emit light, which is recognized as a desired image (luminescent spot).

The image receiver 140 receives the resultant image, and the image inspection unit 141 processes a signal from the image receiver 140. Then, the image inspection unit 141 analyses the position of the electron emitter area EA forming a luminescent spot to display the result on a not shown display. Alternatively, data about the position of the electron emitter area EA is sent to a laser cutting machine.

Alternatively, the detected portion of the discharge site in the gate electrode 13 may be separated from the other portion of the gate electrode 13 in accordance with the method described below. Specifically, a resist layer is applied to the entire surface of the cathode panel CP, and the resist layer is irradiated using a beam of light, and the resist layer is developed so that a portion of the gate electrode 13 to be separated is exposed. Then, the exposed portion of the gate electrode 13 is cut or removed by etching in accordance with a dry etching process, followed by removal of the resist layer.

If desired, instead of separation of the detected portion of the discharge site in the gate electrode from the other portion of the gate electrode, the detected portion of the discharge site in the cathode electrode may be separated from the other portion of the cathode electrode, and this separation inhibits the discharge site from affecting the display operation of the cold cathode field emission display device.

With respect to the field emitter element, a form in which one electron emitter corresponds to one opening is described above, but, depending on the structure, the field emitter element may have a form in which a plurality of electron emitters correspond to one opening or a form in which one electron emitter corresponds to a plurality of openings. Alternatively, the field emitter element may have a form such that a plurality of first openings are formed in the gate electrode and a plurality of second openings in communication with the first openings are formed in the insulating layer to form one or a plurality of electron emitters.

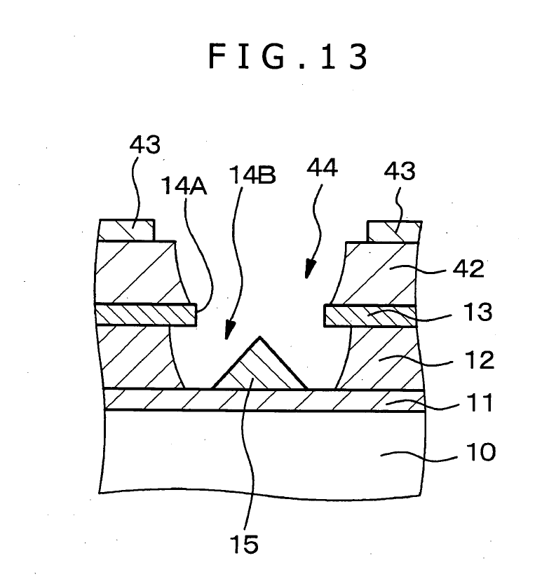

The field emitter element may have a structure in which an interlayer dielectric layer 42 is further formed on the gate electrode 13 and insulating layer 12 and a focusing electrode 43 is formed on the interlayer dielectric layer 42. A diagrammatic fragmentary end view of a field emitter element having such a structure is shown in FIG. 13. In the interlayer dielectric layer 42 is formed a third opening 44 in communication with the first opening 14A. The focusing electrode 43 may be formed by a method in which, for example, in the (Step-A2), the strip-form gate electrode 13 is formed on the insulating layer 12 and then the interlayer dielectric layer 42 is formed, and subsequently, the patterned focusing electrode 43 is formed on the interlayer dielectric layer 42, and then the third opening 44 is formed in the focusing electrode 43 and interlayer dielectric layer 42, and the first opening 14A is formed in the gate electrode 13. Depending on the patterning of the focusing electrode, the focusing electrode may have a form in which focusing electrode units corresponding to one or a plurality of electron emitters or one or a plurality of pixels are assembled, or a form in which the effective region is covered with a conductor in the form of one sheet. In FIG. 13, a Spindt-type field emitter element is shown, but, needless to say, the field emitter element can be of another type.

The gate electrode may have a form in which the effective region is covered with a conductor in the form of one sheet (having openings). In this case, a positive voltage is applied to the gate electrode. A switching element comprised of, e.g., a TFT is disposed between the cathode electrode constituting each pixel and the cathode electrode control circuit, and the state of application to the electron emitter constituting each pixel is controlled by the operation of the switching element to regulate the light emission of the pixel.

The cathode electrode may have a form in which the effective region is covered with a conductor in the form of one sheet. In this case, a voltage is applied to the cathode electrode. A switching element comprised of, e.g., a TFT is disposed between the electron emitter constituting each pixel and the gate electrode control circuit, and the state of application to the gate electrode constituting each pixel is controlled by the operation of the switching element to regulate the light emission of the pixel.

In the cold cathode field emission display device of the present invention, the field emitter element can be of any type, and, for example, the field emitter element can be:

(1) a Spindt-type field emitter element, described in the Example above, such that the conical electron emitter is formed on the cathode electrode at the bottom of the opening;

(2) a flat-type field emitter element such that a substantially plane-form electron emitter is formed on the cathode electrode at the bottom of the opening;

(3) a crown-type field emitter element such that a crown-shaped electron emitter is formed on the cathode electrode at the bottom of the opening and electrons are emitted from the crown-shaped portion of the electron emitter;

(4) a plane-type field emitter element such that electrons are emitted from the surface of the flat cathode electrode;

(5) a crater-type field emitter element such that electrons are emitted from a number of protrusions on the uneven surface of the cathode electrode; or

(6) an edge-type field emitter element such that electrons are emitted from the edge of the cathode electrode.

In the Spindt-type field emitter element, as examples of materials constituting the electron emitter, in addition to molybdenum described in the Example above, there can be mentioned at least one material selected from the group consisting of tungsten, a tungsten alloy, a molybdenum alloy, titanium, a titanium alloy, niobium, aniobium alloy, tantalum, a tantalum alloy, chromium, a chromium alloy, and silicon containing an impurity (polysilicon or amorphous silicon). The electron emitter in the Spindt-type field emitter element can be formed by a vacuum vapor deposition process or, e.g., a sputtering process or a CVD process.

In the flat-type field emitter element, it is preferred that the material constituting the electron emitter has a work function Φ smaller than that of the material constituting the cathode electrode, and the material may be selected depending on the work function of the material constituting the cathode electrode, the potential difference between the gate electrode and the cathode electrode, the required emission current density, or the like. Representative examples of materials constituting the cathode electrode in the field emitter element include tungsten (Φ=4.55 eV), niobium (Φ=4.02 to 4.87 eV), molybdenum (Φ=4.53 to 4.95 eV), aluminum (Φ=4.28 eV), copper (Φ=4.6 eV), tantalum (Φ=4.3 eV), chromium (Φ=4.5 eV), and silicon (Φ=4.9 eV). It is preferred that the electron emitter has a work function Φ smaller than that of the above material, and generally has a work function Φ of 3 eV or less. Examples of such materials include carbon (Φ<1 eV), cesium (Φ=2.14 eV), LaB₆ (Φ=2.66 to 2.76 eV) BaO (Φ=1.6 to 2.7 eV), SrO (Φ=1.25 to 1.6 eV), Y₂O₃ (Φ=2.0 eV), CaO (Φ=1.6 to 1.86 eV), BaS (Φ=2.05 eV), TiN (Φ=2.92 eV), and ZrN (Φ=2.92 eV). It is further preferred that the electron emitter is comprised of a material having a work function Φ of 2 eV or less. The material constituting the electron emitter may not have conductivity.

In the flat-type field emitter element, the material constituting the electron emitter may be appropriately selected from materials having a secondary electron gain δ larger than the secondary electron gain 6 of the conductor constituting the cathode electrode. Specifically, the material constituting the electron emitter can be appropriately selected from metals, such as silver (Ag) aluminum (Al), gold (Au), cobalt (Co), copper (Cu), molybdenum (Mo), niobium (Nb), nickel (Ni), platinum (Pt), tantalum (Ta) tungsten (W), and zirconium (Zr); semiconductors, such as silicon (Si) and germanium (Ge); inorganic simple substances, such as carbon and diamond; and compounds, such as aluminum oxide (Al₂O₃), barium oxide (BaO), beryllium oxide (BeO), calcium oxide (CaO), magnesium oxide (MgO), tin oxide (SnO₂), barium fluoride (BaF₂), and calcium fluoride (CaF₂). The material constituting the electron emitter may not have conductivity.

In the flat-type field emitter element, especially preferred examples of the materials constituting the electron emitter include carbon, specifically, amorphous diamond, graphite, carbon nanotube structures, ZnO whisker, MgO whisker, SnO₂ whisker, MnO whisker, Y₂O₃ whisker, NiO whisker, ITO whisker, In₂O₃ whisker, and A1₂O₃ whisker. When the electron emitter is comprised of the above material, an emission current density required for the cold cathode field emission display device at an electric field strength of 5×10⁷ V/m or less can be obtained. Amorphous diamond is an electrical resistance material and hence can render uniform the emission currents obtained from the individual electron emitters and therefore, when incorporated into the cold cathode field emission display device, it can prevent dispersion of the luminance. Further, the above materials have an extremely high resistance to the sputtering action of ions of the residual gas in the cold cathode field emission display device, thus extending the life of the field emitter element.

Specific examples of carbon nanotube structures include carbon nanotubes and/or graphite nanofibers. More specifically, the electron emitter may be comprised of carbon nanotubes, the electron emitter may be comprised of graphite nanofibers, or the electron emitter may be comprised of a mixture of carbon nanotubes and graphite nanofibers. The carbon nanotubes or graphite nanofibers may be macroscopically in either a powdery form or a thin film form, and, if desired, the carbon nanotube structure may have a conical form. The carbon nanotubes or graphite nanofibers can be produced or formed by a PVD process, such as a known arc discharge process or a laser ablation process, or a CVD process, such as a plasma CVD process, a laser CVD process, a thermal CVD process, a vapor synthesis process, or a vapor growth process.

The flat-type field emitter element can be produced by a method in which a composition including the carbon nanotube structure or the above whisker (hereinafter, these are collectively referred to as “carbon nanotube structure or the like”) dispersed in a binder material is, for example, applied to a desired region of the cathode electrode and then calcined or cured for the binder material (more specifically, a method in which a composition including a carbon nanotube structure or the like dispersed in an organic binder material, such as an epoxy resin or an acrylic resin, or an inorganic binder material, such as water glass, is, for example, applied to a desired region of the cathode electrode, and then the solvent is removed, followed by calcination or curing for the binder material). This method is referred to as first method for forming a carbon nanotube structure or the like. As an example of the application method, there can be mentioned a screen printing process.

Alternatively, the flat-type field emitter element can be produced by a method in which a metal compound solution having dispersed a carbon nanotube structure or the like is applied to the cathode electrode and then calcined for the metal compound, and, in this method, the carbon nanotube structure or the like is fixed to the surface of the cathode electrode through a matrix comprised of metal atoms constituting the metal compound. This method is referred to as second method for forming a carbon nanotube structure or the like. It is preferred that the matrix is comprised of a metal oxide having conductivity, specifically, tin oxide, indium oxide, indium-tin oxide, zinc oxide, antimony oxide, or antimony-tin oxide. After the calcination, a state such that part of each carbon nanotube structure or the like is buried in the matrix can be achieved, or a state such that whole of each carbon nanotube structure or the like is buried in the matrix can be achieved. It is desired that the matrix has a volume resistivity of 1×10⁻⁹ to 5×10⁻⁶ Ω·m.

Examples of metal compounds constituting the metal compound solution include organometal compounds, organic acid metal compounds, and metal salts (such as chlorides, nitrates, and acetates). Specific examples of metal compound solutions including an organic acid metal compound include solutions obtained by diluting an organotin compound, an organoindium compound, an organozinc compound, or an organoantimony compound dissolved in an acid (e.g. hydrochloric acid, nitric acid, or sulfuric acid) with an organic solvent (e.g., toluene, butyl acetate, or isopropyl alcohol). Specific examples of metal compound solutions including an organometal compound include solutions obtained by dissolving an organotin compound, an organoindium compound, an organozinc compound, or an organoantimony compound in an organic solvent (e.g., toluene, butyl acetate, or isopropyl alcohol). A preferred composition includes, relative to 100 parts by weight of the metal compound solution, 0.001 to 20 parts by weight of the carbon nanotube structure or the like and 0.1 to 10 parts by weight of the metal compound. The metal compound solution may contain a dispersant or a surfactant. From the viewpoint of achieving the matrix having an increased thickness, an additive, such as carbon black, may be added to the metal compound solution. If desired, instead of the organic solvent, water can be used as a solvent.

Examples of methods for applying the metal compound solution having dispersed a carbon nanotube structure or the like to the cathode electrode include a spraying process, a spin coating process, a dipping process, a die quarter process, and a screen printing process, and, of these, a spraying process is preferably employed from the viewpoint of facilitating the application.

The metal compound solution having dispersed a carbon nanotube structure or the like is applied to the cathode electrode, and then the metal compound solution is dried to form a metal compound layer. Subsequently, an unnecessary portion of the metal compound layer on the cathode electrode maybe removed, followed by calcination for the metal compound, or an unnecessary portion on the cathode electrode may be removed after the calcination for the metal compound, or the metal compound solution may be applied only to a desired region of the cathode electrode.

The calcination temperature for the metal compound may be a temperature at which, for example, a metal salt is oxidized into a metal oxide having conductivity, or a temperature at which an organometal compound or organic acid metal compound decomposes to form a matrix (e.g., a metal oxide having conductivity) comprised of metal atoms constituting the organometal compound or organic acid metal compound, and, for example, the calcination temperature is preferably 300° C. or higher. The upper limit of the calcination temperature may be a temperature at which the constituents of the field emitter element or cathode panel do not suffer a thermal damage or the like.

In the first method or second method for forming a carbon nanotube structure or the like, it is preferred that, after forming the electron emitter, the surface of the electron emitter is subjected to a kind of activation treatment (cleaning treatment) from the viewpoint of further improving the electron emission efficiency from the electron emitter. Examples of such treatments include plasma treatments in an atmosphere of gas, such as hydrogen gas, ammonia gas, helium gas, argon gas, neon gas, methane gas, ethylene gas, acetylene gas, or nitrogen gas.

In the first method or second method for forming a carbon nanotube structure or the like, the electron emitter may be formed on the surface of a portion of the cathode electrode at the bottom of the opening, and the electron emitter may be formed so that it extends from a portion of the cathode electrode at the bottom of the opening to the surface of the cathode electrode other than the portion at the bottom of the opening. The electron emitter may be formed either on the entire surface or on part of the surface of a portion of the cathode electrode at the bottom of the opening.

The electron emitter area can be comprised of a field emitter element called surface conductive-type field emitter element. The surface conductive-type field emitter element includes, on a support comprised of, e.g., glass, a conductor, such as tin oxide (SnO₂), gold (Au), indium oxide (In₂O₃)/tin oxide (SnO₂), carbon, or palladium oxide (PdO), and a pair of electrodes having a fine area and having a predetermined gap therebetween, which are formed in a matrix form. A carbon thin film is formed on each electrode. A pair of electrodes have a construction such that a horizontal wiring (first electrode) is connected to one of the electrodes and a vertical wiring (second electrode) is connected to another. When a voltage is applied to a pair of electrodes, an electric field is made between the carbon thin films facing each other through a gap, so that electrons are emitted from the carbon thin films. The electrons are permitted to collide with the fluorescent layer on the anode panel, so that the fluorescent layer is excited to emit light, thus obtaining a desired image.

1. A method for treating a cathode panel having a plurality of electron emitter areas arrayed in a two-dimensional matrix form for use in producing a cold cathode field emission display device having a predetermined internal pressure P₀,
the method being characterized by comprising:
(A) placing the cathode panel in a treatment chamber having a predetermined internal pressure P₁ (where P₁>P₀); and then
(B) applying an inspection voltage V_{INS} to each electron emitter area such that each electron emitter area emits electrons, causing discharge in an electron emitter area having an electron emission amount larger than that of another electron emitter area.

2. The method for treating a cathode panel according to claim 1, characterized in that:
the treatment chamber has an inspection electrode;
in the step (A), the cathode panel is placed in the treatment chamber having a predetermined internal pressure P1 and having the inspection electrode in such a manner that the electron emitter areas face the inspection electrode; and
in the step (B), the inspection voltage V_{INS} is applied to each electron emitter area in a state such that a positive voltage is applied to the inspection electrode and that each electron emitter area emits electrons toward the inspection electrode.

3. The method for treating a cathode panel according to claim 1, characterized in that P₁≧10³P₀ is satisfied.

4. The method for treating a cathode panel according to claim 1, characterized in that V_{CUT}≦V_{INS}≦1.1V_{CUT} is satisfied, where V_{CUT} is a cut-off voltage of the cold cathode field emission display device.

5. The method for treating a cathode panel according to claim 1, characterized in that a portion of the electron emitter areas in which discharge was produced is separated from a portion of the electron emitter areas in which no discharge was produced.

6. The method for treating a cathode panel according to claim 1, characterized in that the inspection voltage V_{INS} is constant.

7. The method for treating a cathode panel according to claim 1, characterized in that the inspection voltage V_{INS} is increased with time.

8. The method for treating a cathode panel according to claim 7, characterized in that an emission current resulting from the electrons emitted from the electron emitter areas is measured and, when the emission current has reached a predetermined value, the increasing of the inspection voltage V_{INS} is stopped.

9. The method for treating a cathode panel according to claim 1, characterized in that each electron emitter area includes a first electrode extending in a first direction, a second electrode extending in a second direction different from the first direction, and one or a plurality of electron emitter elements formed in an overlap region between the first electrode and the second electrode.

10. The method for treating a cathode panel according to claim. 9, characterized in that each electron emitter element includes a cold cathode field emitter element which includes:
(a) a cathode electrode formed on a support;
(b) an insulating layer covering the support and the cathode electrode;
(c) a gate electrode formed on the insulating layer;
(d) a plurality of openings formed in portions of the gate electrode and portions of the insulating layer in the overlap region between the cathode electrode and the gate electrode; and
(e) an electron emitter exposed to the bottom of each opening,
wherein the cathode electrode corresponds to the first electrode and the gate electrode corresponds to the second electrode.

11. A method for producing a cold cathode field emission display device, characterized by comprising:
forming a cathode panel by
(A) placing a cathode panel having a plurality of electron emitter areas arrayed in a two-dimensional matrix form in a treatment chamber having a predetermined internal pressure P₁; and then
(B) applying an inspection voltage V_{INS} to each electron emitter area such that each electron emitter area emits electrons, causing discharge in an electron emitter area having an electron emission amount larger than that of another electron emitter area; and
subsequently
(C) separating a portion of the electron emitter areas in which discharge was produced from a portion of the electron emitter areas in which no discharge was produced; and
joining the cathode panel formed and an anode panel together at their edges, the anode panel including a fluorescent region and an anode electrode formed on a substrate;
wherein the cold cathode field emission display device produced has a predetermined internal pressure P₀ (where P₀<P₁).

12. A cold cathode field emission display device characterized by comprising:
a cathode panel formed by
(A) placing a cathode panel having a plurality of electron emitter areas arrayed in a two-dimensional matrix form in a treatment chamber having a predetermined internal pressure P₁; and then
(B) applying an inspection voltage V_{INS} to each electron emitter area such that each electron emitter area emits electrons, causing discharge in an electron emitter area having an electron emission amount larger than that of another electron emitter area; and
subsequently
(C) separating a portion of the electron emitter areas in which discharge was produced from a portion of the electron emitter areas in which no discharge was produced; and
an anode panel joined with the cathode panel formed at their edges, the anode panel including a fluorescent region and an anode electrode formed on a substrate;
wherein the cold cathode field emission display device produced has a predetermined internal pressure P₀ (where P₀<P₁)
